(19) United States
(12) Patent Application Publication
(10) Pub. No.: US 2026/0045864 A1
(43) Pub. Date: Feb. 12, 2026

(54) VIBRATION GENERATOR

(71) Applicant: ALPS ALPINE CO., LTD., Tokyo (JP)

(72) Inventor: Takayuki SUIZU, Miyagi (JP)

(21) Appl. No.: 19/289,351

(22) Filed: Aug. 4, 2025

(30) Foreign Application Priority Data
Aug. 9, 2024 (JP) 2024-134468

(51) Int. Cl. H02K 33/18

(52) U.S. Cl. CPC H02K 33/18

(57) ABSTRACT

A vibration generator includes: a first fixed body having a bottom plate part extending in a first and second directions perpendicular to each other; a first movable body having a first permanent magnet and a first yoke and positioned above the bottom plate part at distance from the bottom plate part in a third direction perpendicular to the first and second directions; a support member supporting the first movable body such that the first movable body vibrates in the first direction, relative to the first fixed body; and main wire bundles and sub wire bundles of coils, positioned above the first movable body at a distance from the first movable body in the third direction, and directly or indirectly attached to the first fixed body, each main wire bundle being composed of conductive wires extending in the second direction, and each sub wire bundle bridging two neighboring main wire bundles.

### CROSS-REFERENCE TO RELATED APPLICATIONS

This application is based on and claims priority to Japanese Patent Application No. 2024-134468, filed on Aug. 9, 2024, the entire content of which is incorporated herein by reference.

### BACKGROUND OF THE INVENTION

### 1. Field of the Invention

The present disclosure relates to a vibration generator.

### 2. Description of the Related Art

There are vibration generators that produce vibrations using magnets. For example, Patent document 1 discloses a vibration generator of this type, in which dowels are formed from a magnet holding part by dowelling in a soft magnetic metal sheet member, and in which a magnet is positioned using the dowels.

### Citation List

### Patent Document

Patent Document 1: Unexamined Japanese Patent Application Publication No. 2018-161047

### SUMMARY OF THE INVENTION

According to one embodiment of the present disclosure, a vibration generator includes:
a first fixed body having a bottom plate part that extends in a first direction and a second direction that is perpendicular to the first direction;
a first movable body having a first permanent magnet and a first yoke, the first movable body being positioned above the bottom plate part, at a distance from the bottom plate part in a third direction that is perpendicular to the first and second directions;
a support member configured to support the first movable body such that the first movable body is allowed to vibrate in the first direction, relative to the first fixed body; and
main wire bundles and sub wire bundles of coils, positioned above the first movable body, at a distance from the first movable body in the third direction, and directly or indirectly attached to the first fixed body, each main wire bundle of coils being composed of a plurality of conductive wires that extend in the second direction, and each sub wire bundle of coils bridging two neighboring main wire bundles of coils.

In this vibration generator:
the first permanent magnet is attached to the first yoke and positioned below the coils;
the first permanent magnet produces a first magnetic flux that travels from the first permanent magnet to the main wire bundles of coils and a second magnetic flux that travels from the main wire bundles of coils to the first permanent magnet;
the first yoke is positioned below the first permanent magnet in the third direction;
the first yoke includes:
   a first planar part on which the first permanent magnet is placed; and
   first movable-body apertures formed in respective positions in the first planar part along a first end side and a second end side of the first planar part, the first end side and the second end side of the first planar part being opposite end sides of the first planar part in the first direction;
where each first movable-body aperture has a plurality of edges in the first direction, an edge that is positioned nearest to the first or second end side of the first planar part, along which said each first movable-body aperture is formed, extends in the second direction;
first movable-body protruding parts are formed in respective positions in the first planar part along the first end side and the second end side of the first planar part, each first movable-body protruding part being formed by shaping a part of the first planar part into a protrusion that points upward in the third direction, and being positioned between: the first or second end side of the first planar part along which said each first movable-body protruding part is formed; and a first movable-body aperture formed along a same end side of the first planar part as where said each first movable-body protruding part is formed; and
where each first movable-body protruding part has a plurality of lateral surfaces that are positioned further from and nearer to the first movable-body aperture formed along the same end side of the first planar part as where said each first movable-body protruding part is formed, the first permanent magnet is held between respective lateral surfaces of the first movable-body protruding parts that are positioned nearest to the first movable-body apertures.

### BRIEF DESCRIPTION OF THE DRAWINGS

FIG. 1 is a perspective view of a vibration generator;

FIG. 2 is an exploded perspective view of the vibration generator;

FIG. 3 is an exploded perspective view of a vibrating part and a non-vibrating part;

FIG. 4 shows perspective views of the non-vibrating part;

FIG. 5 provides diagrams showing an example structure of a base member and an elastic support member;

FIG. 6 shows perspective views of the vibrating part and the non-vibrating part;

FIG. 7 shows perspective views of a drive means;

FIG. 8 shows perspective views of a flat spring;

FIG. 9 shows perspective views of the base member and a bracket;

FIG. 10 provides diagrams showing example structures of a lower yoke and the base member;

FIG. 11 provides diagrams showing example structures of the lower yoke and the base member;

FIG. 12 provides diagrams showing example structures of the lower yoke and the base member;

FIG. 13 provides diagrams showing a positional relationship between the lower yoke and a lower magnet;

FIG. 14 shows a top view and a cross-sectional view of the base member, the bracket, coils, and the vibrating part;

FIG. 15 shows diagrams for explaining how protruding parts formed in the base member work;

FIG. 16 perspective shows views of individual components that constitute the vibration generator;

FIG. 17 shows perspective views of individual components that constitute the vibration generator; and

FIG. 18 is a diagram showing example structures of a lower yoke and a base member in an alternative example of the vibration generator.

### DETAILED DESCRIPTION OF THE PREFERRED EMBODIMENTS

A problem with existing technology when positioning a magnet using dowels is that, as is the case with Patent document 1, it is difficult to form a positioning structure with dowels such that the dowels have a certain level of height and at the same time have vertical side surfaces.

The present disclosure has been made in view of

problems with existing technology such as the one explained above, and aims to provide a vibration generator that can improve the accuracy of positioning of magnets in a structure in which vibrations are produced using the magnets.

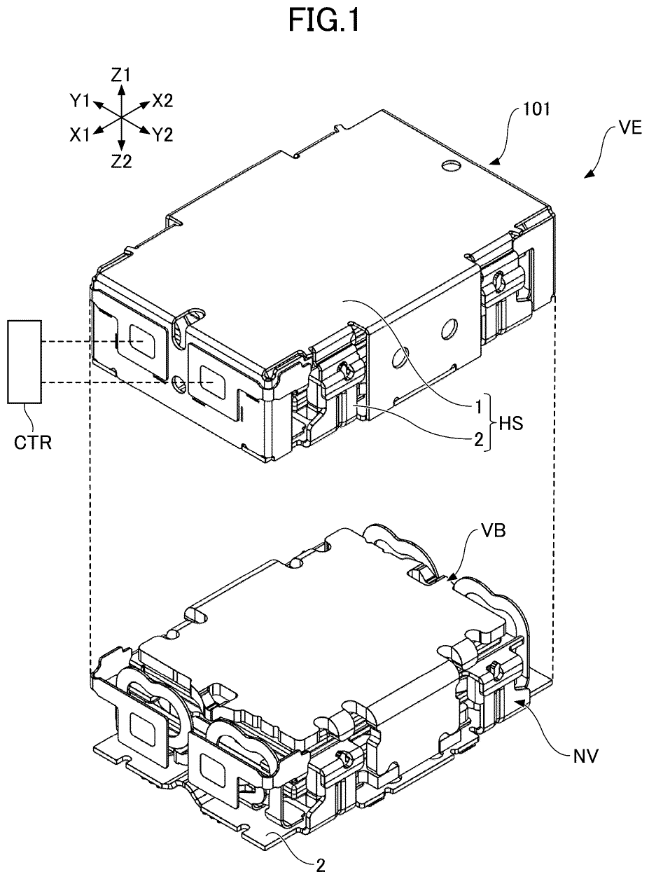

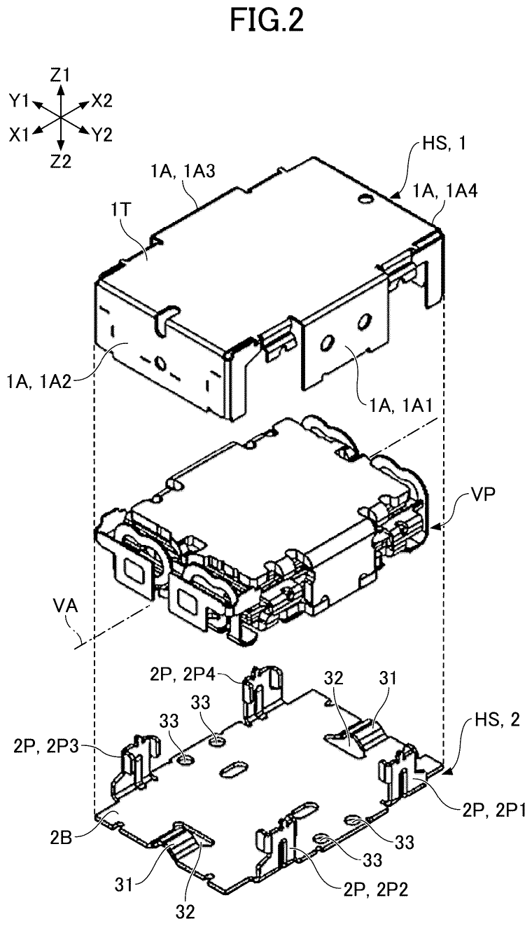

Hereinafter, a vibrating device VE including a vibration generator 101 according to an embodiment of the present disclosure will be described with reference to the accompanying drawings. FIG. 1 is a perspective view of a vibrating device VE including a vibration generator 101 and a control part CTR. To be more specific, the upper figure in FIG. 1 is a perspective view of the vibration generator 101 connected to the control part CTR, and the lower figure in FIG. 1 is a perspective view of the vibration generator 101 without a cover member 1. FIG. 2 is an exploded perspective view of the vibration generator 101.

In FIG. 1 and FIG. 2, “X1” is one direction that the X axis in a three-dimensional Cartesian coordinate system indicates, and “X2” is the opposite direction. The X1 and X2 directions may be collectively referred to as “X direction(s)” when distinction is not necessary. Similarly, “Y1” is one direction that the Y axis in the three-dimensional Cartesian coordinate system indicates, and “Y2” is the opposite direction. The Y1 and Y2 directions may be collectively referred to as “Y direction(s)” when distinction is not necessary. “Z1” is one direction that the Z axis in the three-dimensional Cartesian coordinate system indicates, and “Z2” is the opposite direction. The Z1 and Z2 directions may be collectively referred to as “Z direction(s)” when distinction is not necessary. In the following description of the present embodiment, “X1,” when used with respect to the vibration generator 101, is defined as toward the front side of the vibration generator 101, and “X2” is defined as toward the rear (or back) side of the vibration generator 101. Similarly, “Y1,” when used with respect to the vibration generator 101, is defined as toward the left side of the vibration generator 101, and “Y2” is defined as toward the right side of the vibration generator 101. Also, “Z1,” when used with respect to the vibration generator 101, is defined as toward the upper side of the vibration generator 101, and “Z2” is defined as toward the lower side of the vibration generator 101. The same is true for other figures.

Note that the X-axis direction (that is, both X1 and X2) is an example of a first direction, the Y-axis direction (that is, both Y1 and Y2) is an example of a second direction, and the Z-axis direction (that is, both Z1 and Z2) is an example of a third direction.

Also, “center” as used herein refers to the center position of the vibration generator 101 viewed from the Z direction.

The vibrating device VE has the control part CTR and the vibration generator 101. The vibration generator 101 has a housing HS, a vibrating part VP housed inside the housing HS, and a non-vibrating part NV attached to the housing HS.

As shown in FIG. 1, the housing HS has a substantially rectangular-parallelepiped outer shape. In the present embodiment, the housing HS is made of a non-magnetic material such as austenitic stainless steel. In addition, the housing HS is composed of a cover member 1 and a base member 2.

As shown in FIG. 2, the cover member 1 is structured to form the side surfaces and the upper surfaces of the housing HS, and the base member 2 is structured to form the bottom surface of the housing HS. In FIG. 2, the base member 2 is structured to function as a base for supporting the vibrating part VP.

The cover member 1 is an example of a second fixed part in the present disclosure. Referring to FIG. 2, the cover member 1 has outer wall parts 1A that are substantially rectangular and cylindrical in shape, and a flat top plate part 1T that is provided so as to be continuous with the respective upper ends (Z1 ends) of the outer wall parts 1A, and that extends in the X-axis and Y-axis directions.

The outer wall parts 1A refer to four side plate parts that are shaped flat. To be more specific, as shown in FIG. 2, the outer wall parts 1A have a first side plate part 1A1 and a third side plate part 1A3 that face each other, and a second side plate part 1A2 and a fourth side plate part 1A4 that are perpendicular to the first side plate part 1A1 and the third side plate part 1A3, respectively, and that face each other.

The base member 2 is an example of a first fixed body in the present disclosure. The base member 2 has a flat bottom plate part 2B that extends in the X-axis and Y-axis directions, and support parts 2P that are erect from the edge parts of the bottom plate part 2B. The support parts 2P refer to a first support part 2P1 to a fourth support part 2P4. Protruding parts 31 that protrude in the Z1 direction are formed in parts in the bottom plate part 2B positioned along both end sides of the bottom plate part 2B in the X-axis direction. An aperture 32 is formed next to each of the protruding parts 31. Each protruding part 31 is an example of a fixed-body protruding part in the present disclosure, and each aperture 32 is an example of a fixed-body aperture. These protruding parts 31 and apertures 32 will be described in greater detail later. Furthermore, yoke joint holes 33, which are used when assembling the vibration generator 101, are formed in the bottom plate part 2B.

The control part CTR is configured to enable the vibrating part VP to move. Referring back to FIG. 1, the control part CTR includes an arithmetic circuit and a memory, and is configured to supply an AC current to the vibrating part VP to allow the vibrating part VP to vibrate. Note that, although the control part CTR illustrated is installed outside the housing HS, it may be installed inside the housing HS. In that case, the control part CTR may be provided as one component of the vibration generator 101.

The vibrating part VP is configured such that it can vibrate itself and make the housing HS vibrate. The vibrating part VP illustrated is provided inside the housing HS, so that it can make the housing HS vibrate.

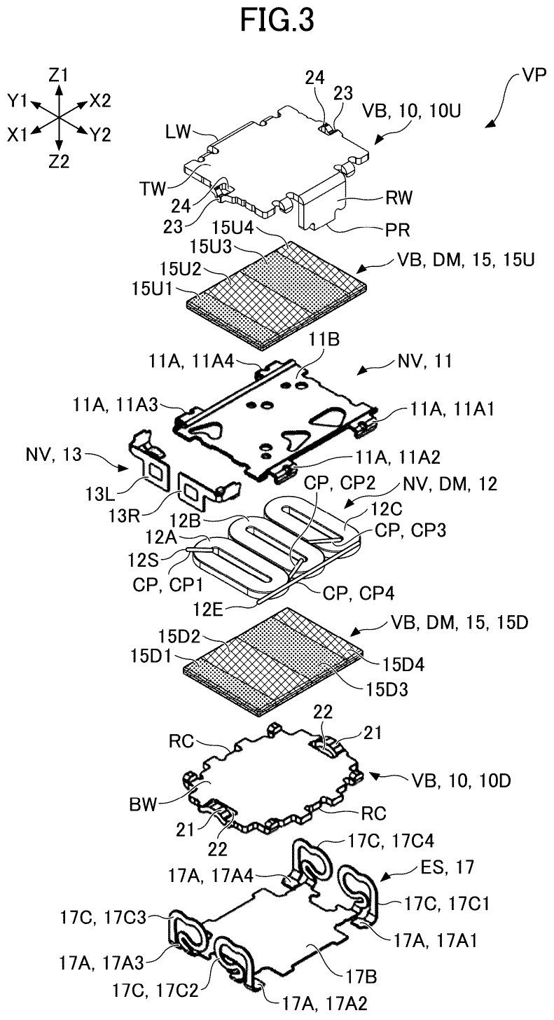

Next, the vibrating part VP will be described in detail with reference to FIG. 3. FIG. 3 is an exploded perspective view of the vibrating part VP. The vibrating part VP includes vibrating bodies VB, drive means DM, and an elastic support member ES.

Each vibrating body VB (hereinafter also referred to as “vibrating element VB”) is a movable element having a predetermined natural frequency, and configured to vibrate, relative to the housing HS, along a vibration axis VA that extends in a predetermined direction (see FIG. 2). Referring to FIG. 3, each vibrating element VB has a predetermined natural frequency and is configured to vibrate, relative to the base member 2, along the vibration axis VA that extends in the X-axis direction (that is, extends forward and backward, or in the “first direction”) (for the vibration axis VA, see FIG. 2).

Each drive means DM is an example of a vibrating force producing part and is configured to make at least a corresponding vibrating element VB vibrate along the vibration axis VA. Referring to FIG. 3, each drive means DM is configured to make at least a corresponding vibrating element VB vibrate along the vibration axis VA, in accordance with supply of AC current through the control part CTR. Each vibrating element VB is elastically supported by the elastic support member ES.

The elastic support member ES is an example of a support member. The elastic support member ES is placed between the housing HS and the vibrating elements VB and supports the vibrating elements VB elastically, thus supporting the vibrating elements VB such that the vibrating elements VB can vibrate in the X-axis direction relative to the housing HS.

To be more specific, the vibrating part VP and the non-vibrating part NV are composed of yokes 10, a bracket 11, coils 12, wire boards 13, magnets 15, and a flat spring 17. As mentioned earlier, the vibrating part VP includes vibrating elements VB, drive means DM, and an elastic support member ES, where the vibrating elements VB include the yokes 10 and the magnets 15, the drive means DM include the coils 12 and the magnets 15, and the elastic support member ES includes the flat spring 17. Furthermore, the non-vibrating part NV includes the bracket 11, the coils 12, and the wire boards 13, and do not vibrate with the vibrating elements VB. Although the non-vibrating part NV is integrally provided in the housing HS and vibrates with the housing HS when the housing HS vibrates, the non-vibrating part NV is connected with the vibrating elements VB via the flat spring 17 and therefore does not vibrate with the vibrating elements VB.

The yokes 10 are members that constitute a magnetic circuit. In this embodiment, the yokes 10 are made of a magnetic material containing iron, etc. Referring to FIG. 3, the yokes 10 refer to two members, namely an upper yoke 10U and a lower yoke 10D, and are made of steel plate cold commercial (SPCC).

The upper yoke 10U is an example of a second yoke in the present disclosure. The upper yoke 10U is a member that forms an upper surface for the vibrating part VP, and has a left side plate part LW, a right side plate part RW, and a top plate part TW. To be more specific, projecting parts PR are formed in the respective Z2 end surfaces of the left side plate part LW and the right side plate part RW. The projecting parts PR can engage with recessed parts RC formed in the lower yoke 10D. The top plate part TW is an example of a second planar part in the present disclosure. Apertures 24, each being an example of a second movable-body aperture, are formed in parts in the top plate part TW positioned along both end sides of the top plate part TW in the X-axis direction, and a protruding part 23 is formed between: each aperture 24; and the end side of the top plate part TW in the X-axis direction along which the aperture 24 is formed. Each protruding part 23 is an example of a second movable-body protruding part in the present disclosure, and formed by deforming a part of the top plate part TW to protrude downward in a mountain-like shape in the Z2 direction. Note that the protruding parts 23 need not be shaped mountain-like as shown in FIG. 3, and may be shaped like the letter “U,” for example. Also, viewing from the Z-axis direction, the edge part that each aperture 24 has next to a protruding part 23 is a rectangle with rounded corners that extends in the Y-axis direction.

The lower yoke 10D is an example of a first yoke in the present disclosure. The lower yoke 10D is a member that forms a lower surface for the vibrating part VP, and includes a bottom plate part BW. To be more specific, recessed parts RC are formed in the Y1 (left) end surface and Y2 (right) end surface of the lower yoke 10D. The recessed parts RC can engage with the projecting parts PR formed in the upper yoke 10U. The bottom plate part BW is an example of a first planar part in the present disclosure. Apertures 22, each being an example of a first movable-body aperture, are formed in parts in the bottom plate part BW positioned along both end sides of the bottom plate part BW in the X-axis direction, and a protruding part 21 is formed between: each aperture 22; and the end side of the bottom plate part BW in the X-axis direction along which the aperture 22 is formed. Each of the protruding parts 21 is an example of a first movable-body protruding part in the present disclosure, and formed by deforming a part of the bottom plate part BW to protrude upward in a mountain-like shape in the Z1 direction, that is, in the direction in which the first permanent magnet is positioned. Note that the protruding parts 21 need not be shaped mountain-like as shown in FIG. 3, and may be shaped like the letter “U,” for example. Also, viewing from the Z-axis direction, the edge part that each aperture 22 has next to a protruding part 21 is a rectangle with rounded corners that extends in the Y-axis direction.

The bracket 11 is an example of a conductive member and configured to support the coils 12 such that the coils 12 face the magnets 15 without contacting the magnets 15. That is, the bracket 11 is configured to function as a coil holder for supporting the coils 12. Also, the bracket 11 is fixedly attached to the base member 2 so as not to contact the vibrating elements VB. In the present embodiment, the bracket 11 is a sheet-like member made of a non-magnetic material such as copper, aluminum, or an alloy thereof, and has anchoring parts 11A and a main plate part 11B. To be more specific, the bracket 11 is fixed to the base member 2 by fastening members, by welding, by an adhesive, by crimping, etc., via four anchoring parts 11A that protrude outward from the main plate part 11B, in a position where the bracket 11 and the coils 12 do not come into contact with the vibrating elements VB even when the vibrating elements VB vibrate. In other words, the bracket 11, to which the coils 12 are attached, is structured not to vibrate with the vibrating elements VB.

The coils 12 are configured to produce a magnetic field when supplied with a current. In the example shown in FIG. 3, the coils 12 include three coil winding parts connected in series (namely, a first coil winding part 12A, a second coil winding part 12B, and a third coil winding part 12C). The first coil winding part 12A, the second coil winding part 12B, and the third coil winding part 12C all have a substantially elliptical shape (i.e., a rectangle with rounded corners) with its longitudinal axis paralleling the Y axis. The coils 12 have a first end 12S where the coils 12 start being wound, and a second end 12E where the winding of the coils 12 ends. The coils 12 are also fixed to the Z2 (lower) surface of the bracket 11 by an adhesive or the like. Therefore, the coils 12 are positioned above, or at a distance in the upper Z-axis direction, from the lower yoke 10D and the lower magnet 15D. The coils 12 are also positioned on the base member 2, indirectly, via the bracket 11. In other words, the coils 12 are provided in indirect contact with the base member 2, on the opposite side of the (lower) side of the lower yoke 10D and the lower magnet 15D facing the base member 2, that is, above the lower yoke 10D and the lower magnet 15D. The surface of the conductive wires (wire material made of copper, copper alloy, etc.) constituting the coils 12 is coated for insulation. In FIG. 3, the coils 12 are illustrated in a simplified manner for ease of understanding, and how the coils 12 are wound is not illustrated in detail. The same applies to other figures as well.

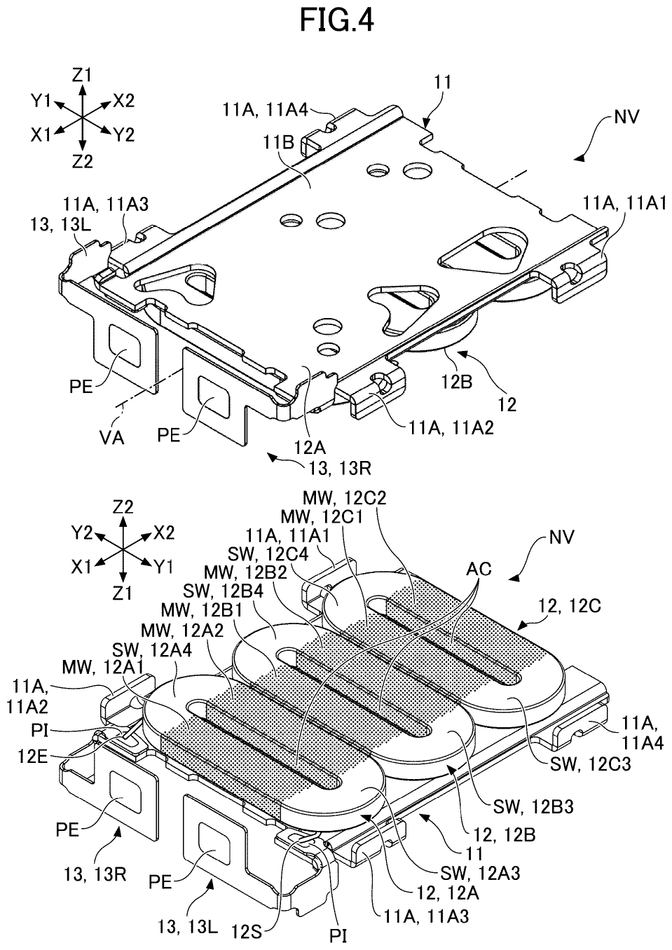

The first end 12S and the second end 12E of the coils 12 are both connected with the wire boards 13. The wire boards 13 are fixed to the 22 (lower) surface of the bracket 11 using an adhesive, as shown in the lower figure in FIG. 4. FIG. 4 shows perspective views of the non-vibrating part NV. To be more specific, the upper figure in FIG. 4 is an upper perspective view of the non-vibrating part NV, and the lower figure in FIG. 4 is a lower perspective view of the non-vibrating part NV.

Referring to FIG. 4, the wire boards 13 are flexible wire boards and refer to a left wire board 13L and a right wire board 13R. Ends of the left wire board 13L and the right wire board 13R are fixed to the X1 (front) end of the bracket 11 by an adhesive or the like. As shown in the lower figure in FIG. 4, the first end 12S of the coils 12 is connected to an inner conductive pattern PI formed in the left wire board 13L by soldering, by a conductive adhesive, etc., and the second end 12E of the coils 12 is connected to an inner conductive pattern PI formed in the right wire board 13R by soldering, by a conductive adhesive, etc. Note that outer conductive patterns PE are formed in both the left wire board 13L and the right wire board 13R and connected to conductive wires from the control part CTR by soldering, by a conductive adhesive, etc.

The first coil winding part 12A, the second coil winding part 12B, and the third coil winding part 12C all have a hollow part AC. Then, the first end 12S, the first coil winding part 12A, the second coil winding part 12B, the third coil winding part 12C, and the second end 12E are connected via conductive wire parts CP. To be more specific, as shown in FIG. 3, the conductive wire parts CP refer to a first conductive wire part CP1 to a fourth conductive wire part CP4. The first end 12S and the first coil winding part 12A are connected by the first conductive wire part CP1. The first coil winding part 12A and the second coil winding part 12B are connected by the second conductive wire part CP2. The second coil winding part 12B and the third coil winding part 12C are connected by the third conductive wire part CP3. The third coil winding part 12C and the second end 12E are connected by the fourth conductive wire part CP4.

Also, as shown in the lower figure in FIG. 4, the coils 12 include main wire bundles MW that extend in the Y-axis direction and sub wire bundles SW that each bridge two neighboring main wire bundles MW. In the example of FIG. 4, each main wire bundle MW has a rectangular shape in top view and includes multiple conductive wires that extend in the Y-axis direction (left and right in the figure), and each sub wire bundle SW has a substantially semicircular shape in top view and includes multiple conductive wires that extend concentrically. For example, the first coil winding part 12A has a front main wire bundle 12A1, a rear main wire bundle 12A2, a left sub wire bundle 12A3, and a right sub wire bundle 12A4. Similarly, the second coil winding part 12B has a front main wire bundle 12B1, a rear main wire bundle 12B2, a left sub wire bundle 12B3, and a right sub wire bundle 12B4, and the third coil winding part 12C has a front main wire bundle 12C1, a rear main wire bundle 12C2, a left sub wire bundle 12C3, and a right sub wire bundle 12C4. The front main wire bundle 12A1, the rear main wire bundle 12A2, the front main wire bundle 12B1, the rear main wire bundle 12B2, the front main wire bundle 12C1, and the rear main wire bundle 12C2 are the main wire bundles MW. Also, the left sub wire bundle 12A3, the right sub wire bundle 12A4, the left sub wire bundle 12B3, the right sub wire bundle 12B4, the left sub wire bundle 12C3, and the right sub wire bundle 12C4 are the sub wire bundles SW. In the lower figure in FIG. 4, the main wire bundles MW of the coils 12 are shown with a dot pattern for ease of understanding.

The magnets 15, each being an example of a magnetic flux producing member, constitute the drive means DM together with the coils 12. In the example shown in FIG. 3, the magnets 15 refer to an upper magnet 15U and a lower magnet 15D. The upper magnet 15U is an example of a second permanent magnet in the present disclosure, and the lower magnet 15D is an example of a first permanent magnet in the present disclosure. The upper magnet 15U and the lower magnet 15D are both eight-pole permanent magnets having a substantially rectangular-parallelepiped outer shape. To be more specific, the upper magnet 15U includes a first upper magnet part 15U1 to a fourth upper magnet part 1504 aligned in the X-axis direction, and the lower magnet 15D includes a first lower magnet part 15D1 to a fourth lower magnet part 15D4 aligned in the X-axis direction. The first upper magnet part 15U1 to the fourth upper magnet part 1504, as well as the first lower magnet part 15D1 to the fourth lower magnet part 15D4, all have, up and below, a part that is magnetized to N polarity (hereinafter “N part”) and a part that is magnetized to S polarity (hereinafter “S part”). In the example illustrated in FIG. 3, the upper surfaces of the first upper magnet part 1501, the third upper magnet part 1503, the first lower magnet part 15D1, and the third lower magnet part 15D3 are all N parts, and the upper surfaces of the second upper magnet part 1502, the fourth upper magnet part 1504, the second lower magnet part 15D2, and the fourth lower magnet part 15D4 are all S parts. Note that, in FIG. 3, the N parts of the 8-pole permanent magnets are shown with a dot pattern and the S parts are shown with a cross pattern, for ease of understanding. The same applies to other figures as well. Note that the upper magnet 15U and the lower magnet 15D may be obtained by combining four two-pole permanent magnets, or by combining two four-pole permanent magnets.

The flat spring 17 is an example of an elastic support member ES, placed between the housing HS and the vibrating elements VB, and configured to support the vibrating elements VB in an elastic manner. In the present embodiment, the flat spring 17 is made of a non-magnetic material such as austenitic stainless steel. As shown in FIG. 3, the flat spring 17 has connecting parts 17A, a vibrating element support part 17B, and elastic arm parts 17C.

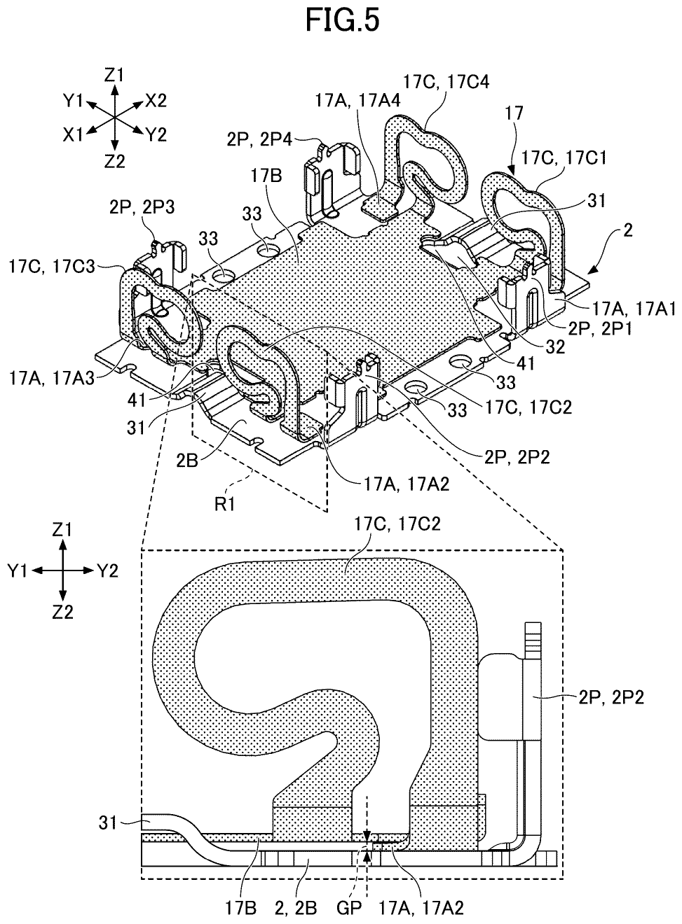

To be more specific, the flat spring 17 may be formed by, for example, punching and bending a 0.2 mm-thick metal sheet made of austenitic stainless steel. To be more specific, referring now to FIG. 5, the connecting parts 17A of the flat spring 17 are welded to the bottom plate part 2B of the base member 2. Then, the flat spring 17 is attached to the base member 2 via the connecting parts 17A alone such that a gap GP having a dimension in the Z-axis direction is formed between the bottom plate part 2B of the base member 2 and the vibrating element support part 17B so as to prevent the vibrating element support part 17B and the elastic arm parts 17C from coming into contact with the base member 2.

The lower yoke 10D and the lower magnet 15D constitute an example of a first movable body in the present disclosure, and the upper yoke 10U and the upper magnet 15U constitute an example of a second movable body in the present disclosure.

FIG. 5 shows example structures of the base member 2 and the elastic support member ES (flat spring 17). To be more specific, the upper figure in FIG. 5 is a perspective view of the base member 2 to which the elastic support member ES (flat spring 17) is attached. The lower figure in FIG. 5 is a front view of the base member 2 to which the elastic support member ES (flat spring 17) is attached, and is an enlarged view of the range R1 framed by a dashed line in the upper figure in FIG. 5. Note that, in FIG. 5, the elastic support member ES (flat spring 17) is shown with a dot pattern for ease of understanding.

In the present embodiment, as shown in the upper figure in FIG. 5, the connecting parts 17A of the flat spring 17 refer to a first connecting part 17A1 to a fourth connecting part 17A4, and the elastic arm parts 17C of the flat spring 17 refer to a first elastic arm part 17C1 to a fourth elastic arm part 17C4. Furthermore, notches 41 are formed by cutting off parts of the vibrating element support part 17B along both end sides of the vibrating element support part 17B in the X-axis direction.

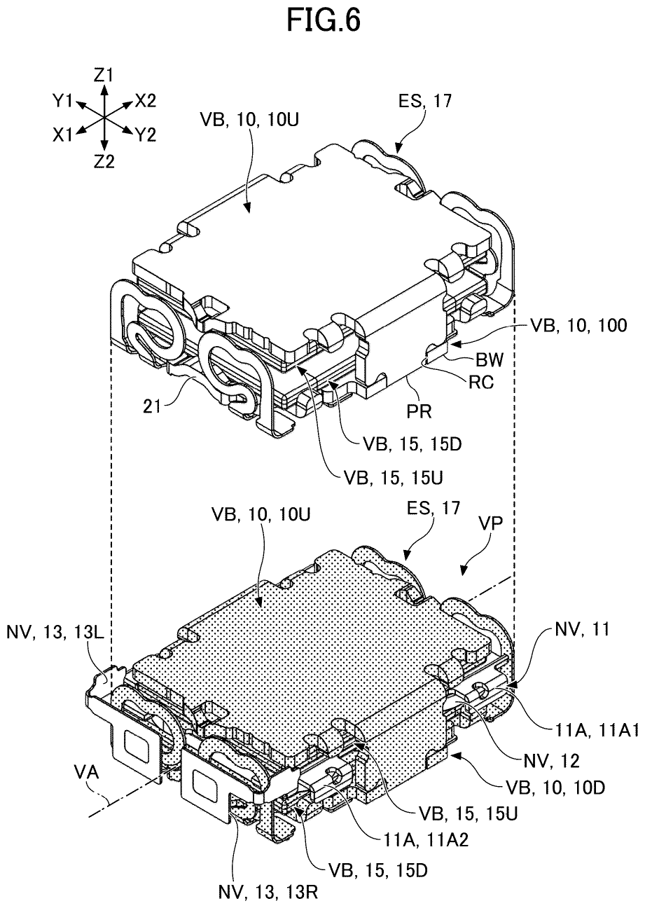

Then, as shown in the upper figure in FIG. 5, the first connecting part 17A1 to the fourth connecting part 17A4 are all fixed to the bottom plate part 2B of the base member 2 by welding. The outer shape of each notch 41 formed in the flat spring 17 and the outer shape of a corresponding aperture 32 formed in the bottom plate part 2B partially overlap each other. Also, referring to FIG. 6, the vibrating elements VB are welded to the vibrating element support part 17B of the flat spring 17. FIG. 6 is a perspective view of the vibrating part VP and the non-vibrating part NV. To be more specific, the upper figure in FIG. 6 is a perspective view of the vibrating part VP and the non-vibrating part NV (namely, the elastic support member ES, the vibrating elements VB, and the magnets 15), not showing certain parts of the non-vibrating part NV (that is, the bracket 11, the coils 12, and the wire boards 13 are missing), and the lower figure in FIG. 6 is a perspective view of the non-vibrating part NV and the vibrating part VP. Note that, in the lower figure in FIG. 6, parts that vibrate (the vibrating elements VB and the elastic support member ES) are shown with a dot pattern for ease of understanding. The dot pattern helps understand that the non-vibrating elements NV, which are not shown with the dot pattern, are fixed to the base member 2 (not shown in the lower figure in FIG. 6) such that the non-vibrating elements NV do not contact the vibrating elements VB, which are shown with a dot pattern. Note that the lower figure in FIG. 1 shows a case in which non-vibrating elements NV are fixed to the base member 2 so as not to come into contact with the vibrating elements VB.

To be more specific, as shown in the upper figure in FIG. 6, the vibrating element VB is composed of the upper yoke 10U, the upper magnet 15U, the lower magnet 15D, and the lower yoke 10D. Then, the Z2 (lower) surface of the bottom plate part BW of the lower yoke 10D is welded to the Z1 (upper) surface of the vibrating element support part 17B of the flat spring 17. By this means, the flat spring 17 is fixed to the base member 2 such that the vibrating element support part 17B is positioned between the base member 2 and the lower yoke 10D in the Z-axis direction.

When an AC current is applied to the coils 12 via the wire boards 13 in the state shown in the lower figure in FIG. 6, the vibrating elements VB vibrate along the vibration axis VA.

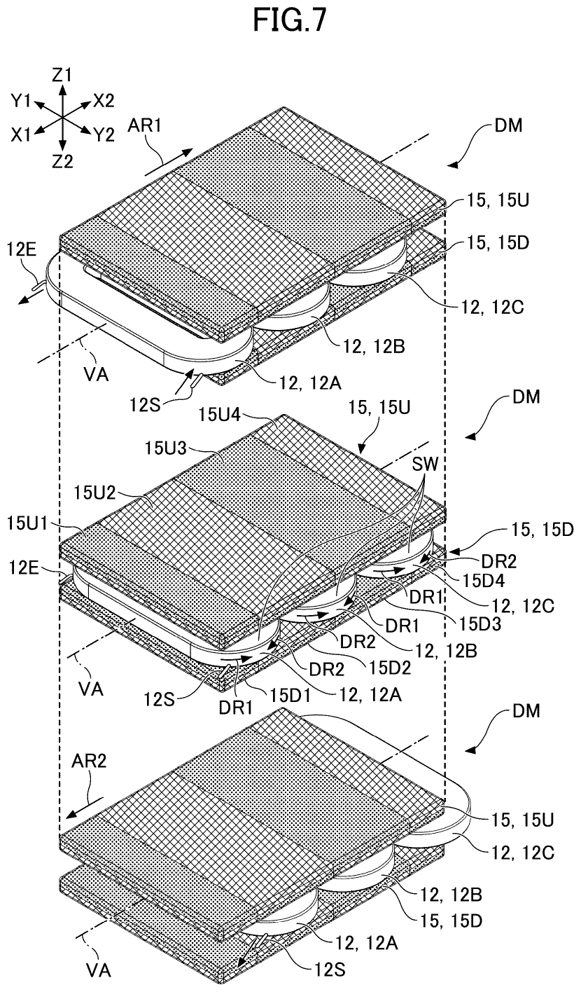

Now, how the components constituting the drive means DM are positioned relative to each other (hereinafter the “positional relationship” of components) when the vibrating elements VB vibrate along the vibration axis VA will be described with reference to FIG. 7. FIG. 7 shows perspective views of components of the drive means DM of the present disclosure. To be more specific, the uppermost figure in FIG. 7 shows the positional relationship between non-vibrating elements NV (coils 12) and vibrating elements

VB (magnets 15) when a current flows in the coils 12 in one direction and the vibrating elements VB (magnets 15) move to the furthest position in the X2 (rear) direction. The middle figure in FIG. 7 shows the positional relationship between non-vibrating elements NV (coils 12) and vibrating elements VB (magnets 15) when there is no current flow in the coils 12. The lowermost figure in FIG. 7 shows the positional relationship between non-vibrating elements NV (coils 12) and vibrating elements VB (magnets 15) when a current flows in the opposite direction in the coils 12 and the vibrating elements VB (magnets 15) move to the furthest position in the X1 (front) direction.

When there is no current flow in the coils 12, the coils 12 are not subject to the Lorentz force. Consequently, as shown in the middle figure in FIG. 7, each magnet 15 is placed in a neutral position where its center faces the center of the coils 12. To be more specific, for example, a vibrating element VB (magnet 15) located in a position away from a neutral position is pre-loaded by the elastic support member ES (flat spring 17) so as to return to the neutral position.

When a current flows from the first end 12S to the second end 12E of the coils 12, the current flows in the first coil winding part 12A, the second coil winding part 12B, and the third coil winding part 12C, in the direction indicated by the arrow labeled “DR1” in the middle figure in FIG. 7. A reaction force from the Lorentz force acts on the vibrating elements VB (magnets 15), which then move in the X2 direction (backward) as indicated by the arrow labeled “AR1” in the uppermost figure in FIG. 7.

Conversely, when a current flows from the second end 12E to the first end 12S of the coils 12, the current flows in the first coil winding part 12A, the second coil winding part 12B, and the third coil winding part 12C, in the direction indicated by the arrow labeled “DR2” in the middle figure in FIG. 7. A reaction force from the Lorentz force acts on the vibrating elements VB (magnets 15), which then move in the X1 direction (forward) as indicated by the arrow labeled “AR2” in the lowermost figure in FIG. 7.

The control part CTR can reverse the direction of the Lorentz force acting on the main wire bundles MW of the coils 12 back and forth, alternately, by reversing the direction of current flow in the coils 12 back and forth, alternately (for example, by applying a sinusoidal current or a square current), thus allowing the vibrating elements VB (magnets 15) to vibrate along the vibration axis VA (in the X-axis direction).

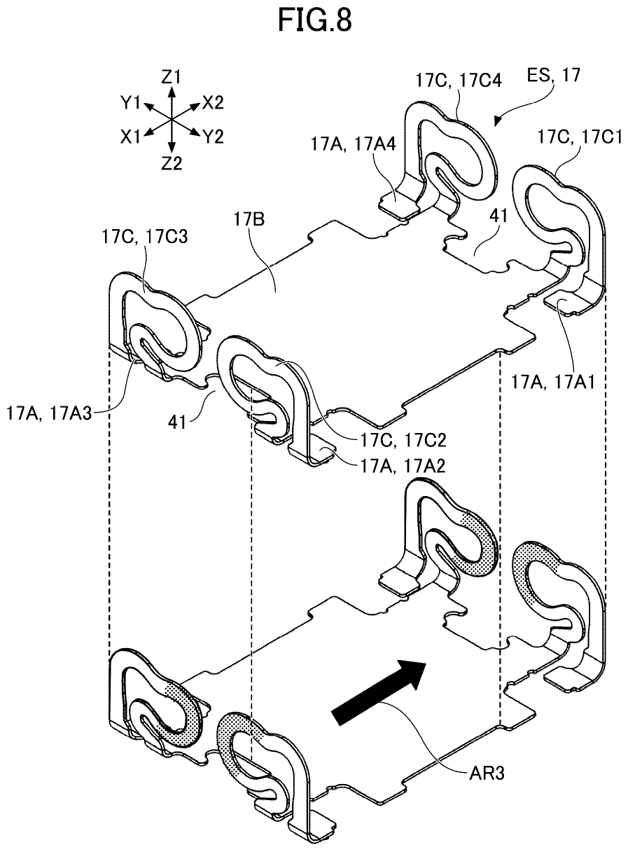

Next, the movement of the elastic arm parts 17C when the vibrating elements VB vibrate will be described with reference to FIG. 8. FIG. 8 shows perspective views of the flat spring 17. To be more specific, the upper figure in FIG. 8 shows the flat spring 17 in a state in which there is no current flow in the coils 12, that is, when the vibrating elements VB are in a neutral position (and do not vibrate). The lower figure in FIG. 8 shows the flat spring 17 in a state in which the vibrating elements VB move in the X2 direction (backward).

As shown in the upper figure in FIG. 8, the elastic arm parts 17C are provided between the connecting parts 17A and the vibrating element support part 17B. To be more specific, the first elastic arm part 17C1 is provided between the first connecting part 17A1 and the vibrating element support part 17B, the second elastic arm part 17C2 is provided between the second connecting part 17A2 and the vibrating element support part 17B, the third elastic arm part 17C3 is provided between the third connecting part 17A3 and the vibrating element support part 17B, and the fourth elastic arm part 17C4 is provided between the fourth connecting part 17A4 and the vibrating element support part 17B.

When the vibrating elements VB (not shown in FIG. 8) are driven by the drive means DM and move in the direction indicated by the arrow labeled “AR3,” the elastic arm parts 17C bend as shown in the lower figure in FIG. 8, so that the vibrating elements VB can move together in the X2 direction. Note that, in FIG. 8, parts of the elastic arm parts 17C where the bending is relatively large are shown with a dot pattern for ease of understanding.

Conversely, when the vibrating elements VB are driven by the drive means DM and move in the direction (X1 direction) opposite to the direction (X2 direction) indicated by the arrow labeled “AR3,” the elastic arm parts 17C bend in the direction opposite to the direction of bending shown in the lower figure in FIG. 8, so that the vibrating elements VB can move together in the X1 direction.

Referring again to FIG. 3, the upper yoke 10U will be described in detail. The upper yoke 10U has a top plate part TW, a right side plate part RW, and a left side plate part LW. To be more specific, the left side plate part LW, which extends in the 22 direction, is formed at the Y1 end of the top plate part TW, and the right side plate part RW, which extends in the 22 direction, is formed at the Y2 end of the top plate part TW. Also, projecting parts PR that engage with the left and right recessed parts RC formed in the lower yoke 10D are formed at the respective lower ends of the left side plate part LW and the right side plate part RW. The upper figure in FIG. 6 shows a state in which the recessed parts RC formed in the lower yoke 10D and the projecting parts PR formed in the upper yoke 10U are engaged with each other.

When assembling the vibrating elements VB together, the upper magnet 15U is attached to the top plate part TW (see FIG. 3) of the upper yoke 10U, the lower magnet 15D is attached to the bottom plate part BW (see FIG. 3) of the lower yoke 10D, and the projecting parts PR of the upper yoke 10U and the recessed parts RC of the lower yoke 10D engage with each other. In this way, in the present embodiment, the upper yoke 10U and the lower yoke 10D surrounding the magnets 15 are provided as separate members so that assembling of the vibrating elements VB is made easier.

Also, as shown in the upper figure in FIG. 6, the Z1 (upper) surface of the upper magnet 15U is held by magnetic force to the Z2 (lower) surface of the top plate part TW of the upper yoke 10U, and the Z2 (lower) surface of the lower magnet 15D is held by magnetic force to the Z1 (upper) surface of the bottom plate part BW of the lower yoke 10D. In this state, the upper magnet 15U is placed at a predetermined position between the two protruding parts 23 formed in the top plate part TW of the upper yoke 10U, and the lower magnet 15D is placed at a predetermined position between the two protruding parts 21 formed in the bottom plate part BW of the lower yoke 10D. This will be described later in greater detail. Furthermore, as shown in the lower figure in FIG. 6, in the space between or surrounded by the upper yoke 10U and the lower yoke 10D, the coils 12 are fixed to the bracket 11 on the 22 side relative to the upper magnet 15U and on the Z1 side relative to the lower magnet 15D, not in contact with the upper magnet 15U and the lower magnet 15D.

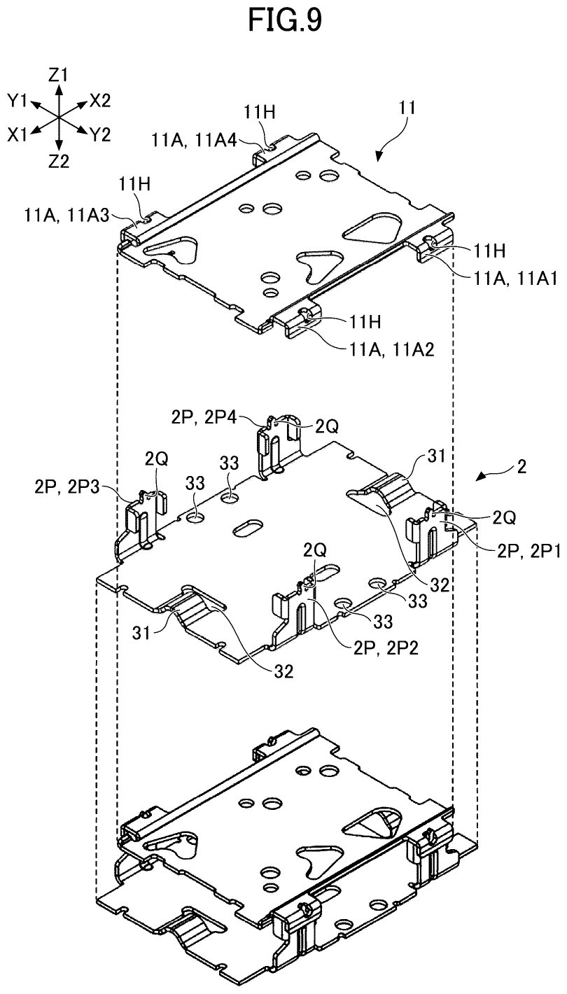

As shown in FIG. 9, the bracket 11 is attached to the base member 2 by making the anchoring parts 11A provided in the bracket 11 and the support parts 2P provided in the base member 2 engage with each other. FIG. 9 provides diagrams showing example structures of the base member 2 and the bracket 11. To be more specific, the uppermost figure in FIG. 9 is a perspective view of the bracket 11, the middle figure in FIG. 9 is a perspective view of the base member 2, and the lowermost figure in FIG. 9 is a perspective view of the bracket 11 as attached to the base member 2.

As shown in FIG. 9, the anchoring parts 11A refer to a first anchoring part 11A1 to a fourth anchoring part 11A4. Also, the support parts 2P refer to a first support part 2P1 to a fourth support part 2P4. The first anchoring part 11A1 engages with the first support part 2P1, the second anchoring part 11A2 engages with the second support part 2P2, the third anchoring part 11A3 engages with the third support part 2P3, and the fourth anchoring part 11A4 engages with the fourth support part 2P4. The anchoring parts 11A and the support parts 2P may be welded together. To be more specific, a through-hole 11H is formed in all of the first anchoring part 11A1 to the fourth anchoring part 11A4, and a projecting part 20 that protrudes upward is formed in all of the first support part 2P1 to the fourth support part 2P4. Then, the first anchoring part 11A1 and the first support part 2P1 may be joined together by, for example, inserting the projecting part 20 of the first support part 2P1 through the through-hole 11H of the first anchoring part 11A1 and then emitting laser light on the projecting part 20. The second anchoring part 11A2 and the second support part 2P2, the third anchoring part 11A3 and the third support part 2P3, and the fourth anchoring part 11A4 and the fourth support part 2P4 may also be joined together in the same manner. However, the anchoring parts 11A and the support parts 2P may be joined together by fastening members, by an adhesive, by crimping, etc. The bracket 11 may be attached to the housing HS by clamping the anchoring parts 11A between the support parts 2P and the cover member 1.

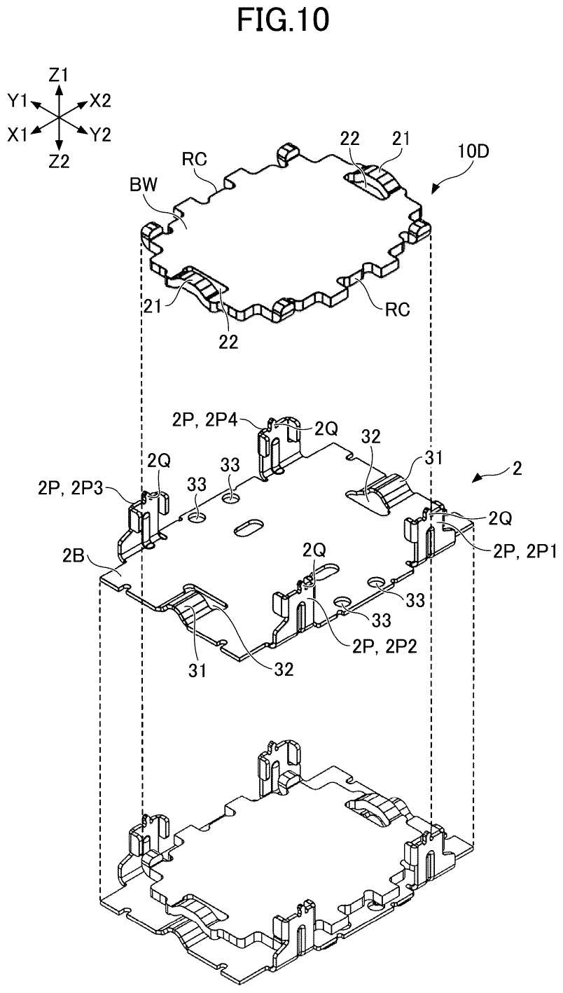

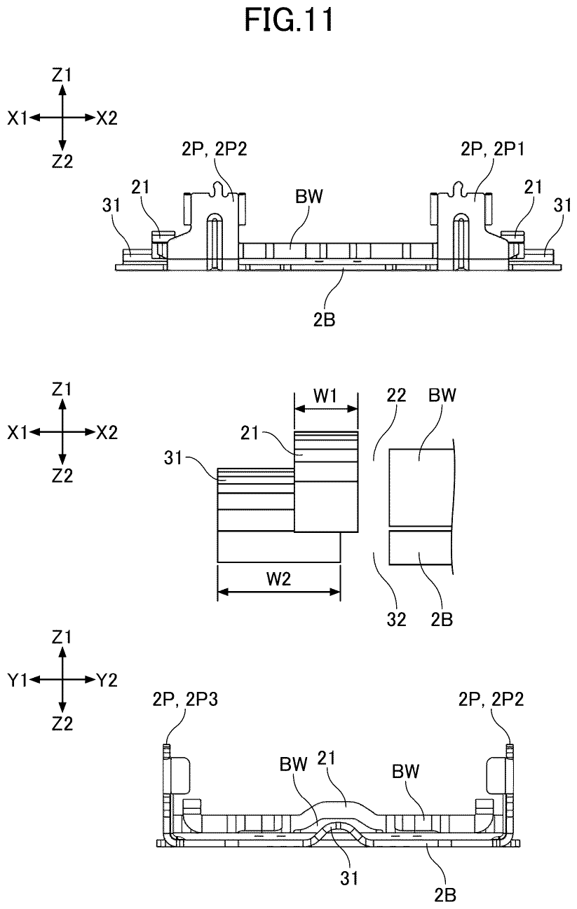

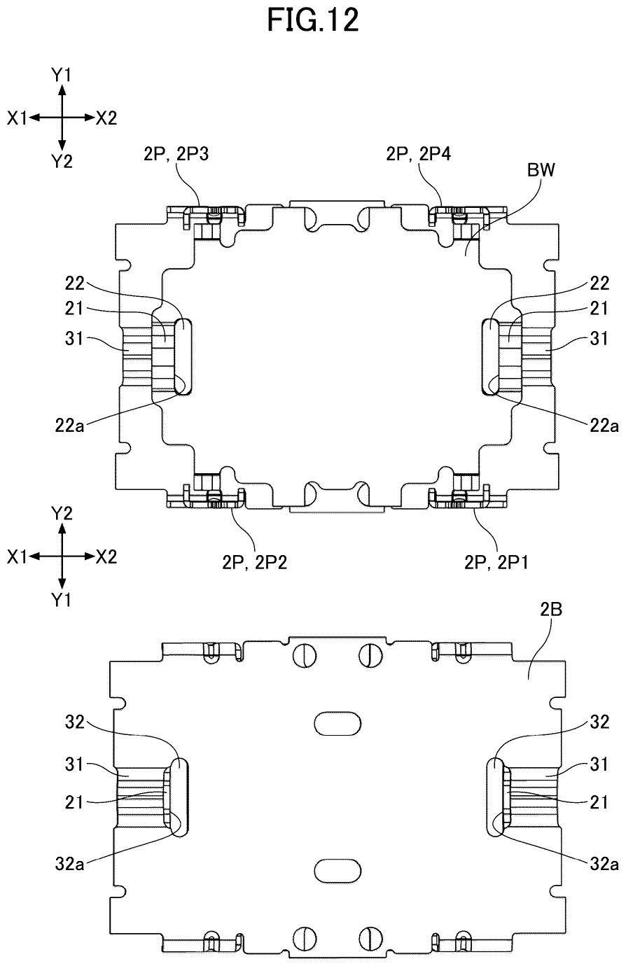

Now, the positional relationship between the lower yoke 10D and the base member 2 will be explained. FIG. 10 to FIG. 12 are diagrams showing example structures of the lower yoke 10D and the base member 2. To be more specific, the uppermost figure in FIG. 10 is a perspective view of the lower yoke 10D, the middle figure in FIG. 10 is a perspective view of the base member 2, and the lowermost figure in FIG. 10 is a perspective view showing the positional relationship between the lower yoke 10D and the base member 2. The uppermost figure in FIG. 11 is a diagram showing the positional relationship between the lower yoke 10D and the base member 2 seen from the Y2 direction. The middle figure in FIG. 11 is a diagram showing the positional relationship between: the protruding parts 21 and the apertures 22 of the lower yoke 10D; and the protruding parts 31 and the apertures 32 of the base member 2, seen from the Y2 direction. The lowermost figure in FIG. 11 is a diagram showing the positional relationship between the lower yoke 10D and the base member 2 seen from the X1 direction. The upper figure in FIG. 12 is a diagram showing the positional relationship between the lower yoke 10D and the base member 2 seen from the Z1 direction. The lower figure in FIG. 12 is a diagram showing the positional relationship between the lower yoke 10D and the base member 2 seen from the 22 direction. Note that, in FIG. 10 to FIG. 12, the flat spring 17 is omitted in order to help understand the positional relationship between the lower yoke 10D and the base member 2 more easily. Also, FIG. 10 to FIG. 12 show the positional relationship between the lower yoke 10D and the base member 2 when there is no current flow in the coils 12, that is, when the vibrating elements VB are in a neutral position as in the middle figure in FIG. 7.

In the bottom plate part BW of the lower yoke 10D, a part positioned along each end side in the X-axis direction is formed into an aperture 22, and a part positioned between the same end side and aperture 22 is formed into a protruding part 21, providing apertures 22 and protruding parts 21 at both end sides of the bottom plate part BW in the X-axis direction. Each protruding part 21 is formed by deforming a part of the bottom plate part BW between one end side of the bottom plate part BW in the X-axis direction and the aperture 22 formed along the same end side, to protrude upward, in the Z1 direction, in a mountain-like shape. So, each protruding part 21 is highest in its center in the Y-axis direction and gradually becomes lower toward its ends in the Y-axis direction. The parts of each protruding part 21 that meet both ends of a corresponding aperture 22 in the Y-axis direction are the edging parts of the protruding part 21. Among multiple edge parts that each aperture 22 has, the edge part that each aperture 22 has nearest to the same end side of the bottom plate part BW as where the aperture 22 is formed, that is, the edge part 22a that the aperture 22 has nearest to a protruding part 21, is a rectangle with rounded corners, extending in the Y-axis direction.

Meanwhile, in the bottom plate part 2B of the base member 2, a part positioned along each end side in the X-axis direction is formed into a protruding part 31, which protrudes upward in the 21 direction, and an aperture 32 is formed next to the protruding parts 31, providing protruding parts 31 and apertures 32 at both end sides of the bottom plate part 2B in the X-axis direction. Each protruding part 31 is formed by deforming a part of the bottom plate part 2B between one end side of the bottom plate part 2B in the X-axis direction and the aperture 32 formed along the same end side, to protrude upward, in the Z1 direction, in a mountain-like shape. So, each protruding part 31 is highest in its center in the Y-axis direction and gradually becomes lower toward its ends in the Y-axis direction. The parts of each protruding part 31 that meet both ends of a corresponding aperture 32 in the Y-axis direction are the edging parts of the protruding part 31. Among multiple edge parts that each aperture 32 has, the edge part that each aperture 32 has nearest to the same end side of the bottom plate part 2B as where the aperture 32 is formed, that is, the edge part 32a that each aperture 32 has nearest to a protruding part 31, is a rectangle with rounded corners, extending in the Y-axis direction.

The lower yoke 10D is attached to the base member 2 via the flat spring 17. To be more specific, the flat spring 17 is attached to the base member 2 via the connecting parts 17A, and the lower yoke 10D is attached to the vibrating element support part 17B of the flat spring 17 by welding or the like.

In this case, the height of the protruding parts 21 and 31 structured as described above is adjusted such that, when the lower yoke 10D is attached to the base member 2 via the flat spring 17, each protruding part 31 can be inserted under a protruding part 21, as shown in the lowermost figure in FIG. 11. Adjusting the height of the protruding parts 21 and 31 thus allows the protruding parts 31 to be inserted under the protruding parts 21. Consequently, even when there is no current flow in the coils 12 and no repulsive or attractive force is at work between the coils 12 and the magnets 15, as shown in FIG. 11, a part of each protruding part 31 is inserted under a protruding part 21, so that the protruding parts 21 and the protruding parts 31 partially overlap each other in the Z-axis direction. That is, each protruding part 31 is placed in a part where it at least partially overlaps a protruding part 21 in the Z-axis direction. Furthermore, the height of the protruding parts 31 is adjusted such that each protruding part 31 can contact an end surface of the bottom plate part BW of the lower yoke 10D, as shown in the lowermost figure in FIG. 11. Also, the width W2 of the protruding parts 31 in the X-axis direction is wider than the width W1 of the protruding parts 21 in the X-axis direction.

As shown in FIG. 12, the apertures 22 and 32 are formed such that their respective outer shapes partially overlap each other when the lower yoke 10D is attached to the base member 2 via the flat spring 17. To be more specific, the apertures 22 and 32 are formed in positions where they overlap each other when the lower yoke 10D is attached to the base member 2 via the flat spring 17. Note that this is a state in which there is no current flow in the coils 12 and in which therefore no repulsive or attractive force is at work between the coils 12 and the magnets 15. As for the size and shape of the apertures 22 and 32, both are rounded rectangular shapes and have substantially equal lengths in the longitudinal and lateral directions, which makes the apertures 22 and 32 the same or partially the same in shape. Note that the apertures 22 and 32 may be completely the same shape as well.

The lower magnet 15D is placed on the bottom plate part BW of the lower yoke 10D structured thus.

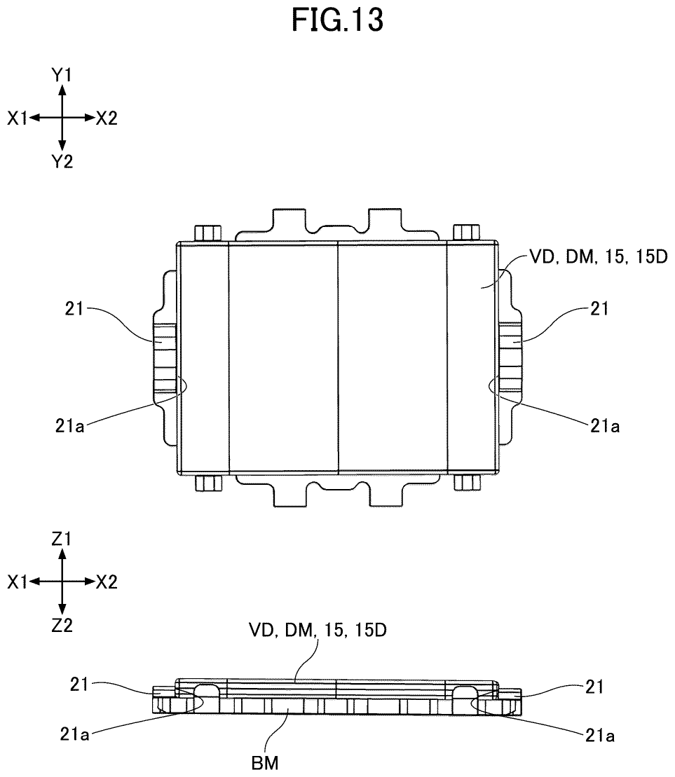

FIG. 13 is a diagram showing the positional relationship between the lower yoke 10D and the lower magnet 15D. To be more specific, the upper figure in FIG. 13 shows a state, viewed from the Z1 direction, in which the lower magnet 15D is mounted on the bottom plate part BW of the lower yoke 10D, and the lower figure in FIG. 13 shows a state, viewed from the Y2 direction, in which the lower magnet 15D is mounted on the bottom plate part BW of the lower yoke 10D.

The lower magnet 15D is laid over the upper surface of the bottom plate part BW such that the lower magnet 15D fits in between the two protruding parts 21 formed in the bottom plate part BW of the lower yoke 10D. The spacing between the respective end surfaces 21a of the two protruding parts 21 formed in the bottom plate part BW of the lower yoke 10D is preferably equal to the length of the lower magnet 15D in the X axis direction. By this means, as shown in FIG. 13, the lower magnet 15D is positioned relative to the lower yoke 10D, by the end surface 21a of each of the protruding parts 21 facing an aperture 22, that is, placed at a predetermined position that is determined by the positions of two protruding parts 21. Note that, although the lower magnet 15D has been described to be placed at a predetermined position, the positioning of the lower magnet 15D is by no means limited to one specific point, and cases in which the lower magnet 15D has only to be positioned within a specific range are applicable as well.

The lower magnet 15D is positioned between two protruding parts 21 formed in the bottom plate part BW of the lower yoke 10D, and, in this state, attached to the bottom plate part BW of the lower yoke 10D by magnetic force. Note that the lower magnet 15D may also be attached to the bottom plate part BW of the lower yoke 10D using an adhesive or the like.

Two protruding parts 21 are thus provided at both end sides of the bottom plate part BW in the X-axis direction, and the lower magnet 15D is held between the end surface 21a that each protruding part 21 has nearest to an aperture 22 (that is, between the end surface 21a that each protruding part 21 has nearest to the center of the vibration generator 101).

Each protruding part 21 is formed by shaping a part of the bottom plate part BW into a mountain-like protrusion that points in the Z1 direction, creating a space underneath each protruding part 21. Consequently, even when the protruding parts 21 are made taller in the Z direction, each protruding part 21 supports a part of the lower magnet 15D that is positioned high in the X direction, which is the direction in which the lower magnet 15D vibrates, so that the lower magnet 15D can be positioned more reliably in the X-axis direction. Improving the accuracy of positioning of the magnets 15 in the X-axis direction relative to the coils 12 allows an increase of the Lorentz force. Also, since the protruding parts 21 are formed by deforming parts of the bottom plate part BW to protrude in the Z1 direction, their strength can be easily improved by increasing their width W1 in the X-axis direction. Also, since the protruding parts 21 are provided in a mountain-like shape in which each protruding part 21 is highest in its center in the Y-axis direction and gradually becomes lower toward its ends in the Y-axis direction, and in which the parts of each protruding part 21 that meet both ends of an aperture 22 in the Y-axis direction are the edging parts of the protruding part 21, the strength of the protruding parts 21 can be improved compared to when both ends of each protruding part 21 in the Y-axis direction are connected vertically with the bottom plate part 2B.

Note that, similar to the lower magnet 15D, the upper magnet 15U is also held in a predetermined position determined by the positions of the two protruding parts 23 formed in the upper yoke 10U, that is, held in a position determined by the end surface of each protruding part 23 facing an aperture 24.

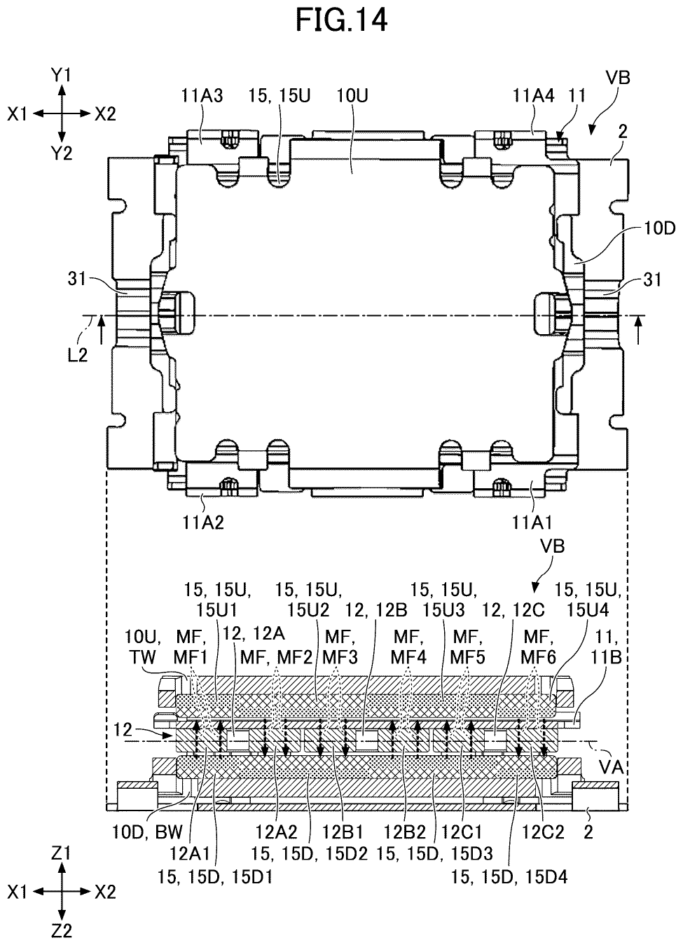

Next, how the magnets 15 produce magnetic fluxes will be explained with reference to FIG. 14. FIG. 14 provides diagrams showing example structures of the base member 2, the bracket 11, the coils 12, and the vibrating elements VB. To be more specific, the upper figure in FIG. 14 is a top view of the base member 2, the bracket 11, and the vibrating elements VB. The lower figure in FIG. 14 is a cross-sectional view of the base member 2, the bracket 11, the coils 12, and the vibrating elements VB. To be more specific, the lower figure in FIG. 14 is a cross-section of the base member 2, the bracket 11, the coils 12, and the vibrating elements VB, in a virtual plane that is parallel to the XZ plane including the dashed line L2 in the upper figure in FIG. 14, viewed from the Y2 direction. To be even more specific, in the lower figure in FIG. 14, the vibrating elements VB include the upper yoke 10U, the upper magnet 15U, the lower magnet 15D, and the lower yoke 10D, and the coils 12 are placed in the space between or surrounded by the upper yoke 10U and the lower yoke 10D (the space between the upper magnet 15U and the lower magnet 15D). The magnets 15 produce magnetic fluxes as represented by the magnetic field lines MF of dotted lines in the lower figure in FIG. 14. In the example shown in the lower figure in FIG. 14, the magnetic field lines MF include a first magnetic field line MF1 to a sixth magnetic field line MF6.

To be more specific, when there is no current flow in the coils 12, the first magnetic field line MF1 starts off from the N part of the first lower magnet part 15D1 of the lower magnet 15D, passes through the front main wire bundle 12A1 of the first coil winding part 12A, and enters the S part of the first upper magnet part 15U1 of the upper magnet 15U. Similarly, the second magnetic field line MF2 starts off from the N part of the second upper magnet part 15U2 of the upper magnet 15U, passes through the rear main wire bundle 12A2 of the first coil winding part 12A, and enters the S part of the second lower magnet part 15D2 of the lower magnet 15D. The third magnetic field line MF3 starts off from the N part of the second upper magnet part 15U2 of the upper magnet 15U, passes through the front main wire bundle 12B1 of the second coil winding part 12B, and enters the S part of the second lower magnet part 15D2 of the lower magnet 15D. The fourth magnetic field line MF4 starts off from the N part of the third lower magnet part 15D3 of the lower magnet 15D, passes through the rear main wire bundle 12B2 of the second coil winding part 12B, and enters the S part of the third upper magnet part 1503 of the upper magnet 15U. The fifth magnetic field line MF5 starts off from the N part of the third lower magnet part 15D3 of the lower magnet 15D, passes through the front main wire bundle 12C1 of the third coil winding part 12C, and enters the S part of the third upper magnet part 1503 of the upper magnet 15U. The sixth magnetic field line MF6 starts off from the N part of the fourth upper magnet part 1504 of the upper magnet 15U, passes through the rear main wire bundle 12C2 of the third coil winding part 12C, and enters the S part of the fourth lower magnet part 15D4 of the lower magnet 15D. That is, referring to the lower figure in FIG. 14, the lower magnet 15D produces a first magnetic flux that travels from the lower magnet 15D toward the main wire bundles of the coils 12, and that is represented by the first magnetic field line MF1, the fourth magnetic field line MF4, and the fifth magnetic field line MF5. The lower magnet 15D also produces a second magnetic flux that travels from the main wire bundles of the coils 12 toward the lower magnet 15D, and that is represented by the second magnetic field line MF2, the third magnetic field line MF3, and the sixth magnetic field line MF6. Similarly, the upper magnet 15U produces a third magnetic flux that travels from the upper magnet 15U toward the bundles of the coils 12, and that is represented by the second magnetic field line MF2, the third magnetic field line MF3, and the sixth magnetic field line MF6. The upper magnet 15U also produces a fourth magnetic flux that travels from the bundles of the coils 12 toward the upper magnet 15U, and that is represented by the first magnetic field line MF1, the fourth magnetic field line MF4, and the fifth magnetic field line MF5.

It then follows that, in the space between or surrounded by the upper yoke 10U and the lower yoke 10D, the magnetic field lines concentrate in the partial spaces between the upper magnet 15U and the lower magnet 15D, making the magnetic flux density of the spaces high; the coils 12 are placed in these partial spaces. This structure can therefore produce the Lorentz force efficiently by applying a current between the first end 12S and the second end 12E of the coils 12, thus allowing the vibrating elements VB to vibrate in the X-axis direction in an efficient way.

For example, when a current flows from the first end 12S to the second end 12E of the coils 12, the vibrating elements VB move in the X2 direction (backward). When a current flows from the second end 12E to the first end 12S of the coils 12, the vibrating elements VB move in the X1 direction (forward). Therefore, the control part CTR can make the vibrating elements VB vibrate along the vibration axis VA by applying a current to the coils 12 such that the direction of current flow in the coils 12 is reversed back and forth alternately. Note that the bracket 11, to which the coils 12 are attached, is fixed to the base member 2, but is not fixed to the vibrating elements VB, so that the bracket 11 and the coils 12 do not vibrate with the vibrating elements VB.

Also, when the vibrating elements VB vibrate along the vibration axis VA, the magnetic fluxes (hereinafter referred to as “effective magnetic fluxes”) that are produced and extend in the Z-axis direction between the upper magnet 15U and the lower magnet 15D included in the vibrating elements VB produce vibrations along the vibration axis VA. That is, although the bracket 11 is a non-magnetic conductive member and provided between the upper magnet 15U and the lower magnet 15D, the effective magnetic fluxes still cross the bracket 11 and produce vibrations along the vibration axis VA. As a consequence of this, an eddy current flows in the main plate part 11B of the bracket 11. Note that, in the examples illustrated in FIG. 14, the upper magnet 15U, the lower magnet 15D, and the bracket 11 are positioned such that the effective magnetic fluxes and the main plate part 11B are orthogonal to each other.

The vibrating elements VB are constantly subjected to a retarding force, which is an eddy current-induced force that acts in the opposite direction when the vibrating elements VB vibrate in a certain direction. To be more specific, the vibrating elements VB vibrate, driven by the Lorentz force produced by the drive means DM, and, at the same time, a retarding force acts on the vibrating elements VB to decelerate their vibrations. The retarding force increases in proportion to the speed at which the vibrating elements VB vibrate. Therefore, the rate of acceleration (of vibrations) at the natural frequency of the vibrating elements VB and nearby frequencies is slowed down by the retarding force. Also, although the vibrating elements VB continue vibrating at slower rates due to inertia even after the supply of sinusoidal current or square current to the coils 12 ceases, the retarding force enables a quick stop.

A greater eddy current produces a greater retarding force. Also, the eddy current in the main plate part 11B of the bracket 11 increases in inverse proportion to the resistivity of the conductive member (bracket 11), increases in proportion to the conductivity of the conductive member (bracket 11), and increases in proportion to the thickness of the conductive member (bracket 11), that is, the thickness of the main plate part 11B. Therefore, the material and thickness of the bracket 11 are chosen such that a desired level of retarding force is obtained. In this example, the bracket 11 is made of tough pitch copper, which is the same material as the wire material of the coils 12, and is approximately 0.3 mm-thick.

This structure allows the vibration generator 101 to have improved durability compared to when a viscoelastic member is provided between the vibrating elements VB and the non-vibrating part NV to produce a retarding force. This is because the bracket 11 is less affected by factors such as ambient temperature, dimensional variations, wear, peeling, tearing, etc., to which a viscoelastic member is susceptible.

If a large impact such as one that occurs when the vibration generator 101 is dropped from a certain height is applied to the vibration generator 101, the vibrating elements VB may hit the elastic arm parts 17C of the flat spring 17 with a strong force, and the excessive load that applies to the flat spring 17 then may cause the flat spring 17 to bend or be deformed. In the present embodiment, therefore, the vibration generator 101 is structured such that the protruding parts 31 formed in the base member 2 receive the impact from the vibrating elements VB. How the protruding parts 31 formed in the base member 2 work will be described below.

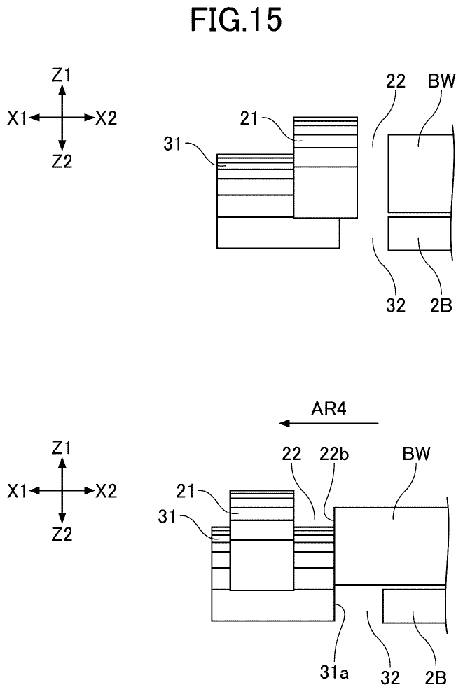

FIG. 15 shows diagrams for explaining how the protruding parts 31 formed in the base member 2 work.

As described earlier with reference to FIG. 11, the positions and height of the protruding parts 31 in the base member 2 are determined such that the protruding parts 31 can be inserted under the protruding parts 21 when the lower yoke 10D is attached to the base member 2 via the flat spring 17. Also, the height of the protruding parts 31 is adjusted such that each protruding part 31 can contact an end surface of the bottom plate part BW of the lower yoke 10D.

Structured thus, as shown in the upper figure in FIG. 15, the protruding parts 31 formed in the base member 2 are positioned below the protruding parts 21 formed in the lower yoke 10D.

In this state, if a large impact such as one that occurs when the vibration generator 101 is dropped from a certain height is applied to the vibration generator 101, the vibrating elements VB move significantly in the direction indicated by the arrow labeled “AR4” in the lower figure in FIG. 15. Since the height of the protruding parts 31 is adjusted such that each protruding part 31 can contact an end surface of the bottom plate part BW of the lower yoke 10D, the inner edge surface 22b that each aperture 22 in the lower yoke 10D has on the opposite side relative to a corresponding protruding part 21, and the end surface 31a that each protruding part 31 in the base member 2 has nearest to the center of the base member 2 in the X-axis direction, that is, the end surface 31a facing a corresponding aperture 32, are brought into contact with each other. When an inner edge surface 22b of each aperture 22 and an end surface 31a of each protruding part 31 are in contact with each other thus, the vibrating elements VB and the elastic arm parts 17C are positioned not to contact each other in the X-axis direction, and a gap is created between them. Also, the above-described contact of an inner edge surface 22b of each aperture 22 and an end surface 31a of the corresponding protruding part 31 does not take place while the vibrating elements VB are vibrating.

When an inner edge surface 22b and an end surface 31a come into contact with each other as described above, the vibrating elements VB including the lower yoke 10D cannot move any further in the X1 direction, thus preventing the flat spring 17 from being exposed to excessive load and deforming. In this way, by bringing the inner edge surface 22b that each aperture 22 formed in the lower yoke 10D has on the opposite side relative to a corresponding protruding part 21 and the end surface 31a that each protruding part 31 formed in the base member 2 has nearest to the center of the base member 2 in the X-axis direction, that is, the end surface 31a facing a corresponding aperture 32, into contact with each other, the movement of vibrating elements VB including the lower yoke 10D in the X-axis direction is blocked.

The lower magnet 15D is placed and held in a predetermined position by the protruding parts 21 of the lower yoke 10D, and thus the protruding parts 21 of the lower yoke 10D also block the movement of the lower magnet 15D in the X-axis direction relative to the lower yoke 10D. Similarly, the upper magnet 15U is placed and held in a predetermined position by the protruding parts 23 of the upper yoke 10U, and thus the protruding parts 23 of the upper yoke 10U also block the movement of the upper magnet 15U in the X-axis direction relative to the upper yoke 10U.

When blocking the movement of the lower magnet 15D in the X-axis direction relative to the lower yoke 10D, it suffices to support only the weight of the lower magnet 15D. Similarly, when blocking the movement of the upper magnet 15U in the X-axis direction relative to the upper yoke 10U, it suffices to support only the weight of the upper magnet 15U. Unlike the foregoing, when blocking the movement of vibrating elements VB in the X-axis direction, it is necessary to support the weight of the vibrating elements VB, including the lower yoke 10D, the lower magnet 15D, the upper yoke 10U, and the upper magnet 15U. Therefore, as described earlier with reference to FIG. 11, the width W2 of the protruding parts 31 in the X-axis direction is wider than the width W1 of the protruding parts 21 in the X-axis direction.

As a result of this, even when a large impact such as one that occurs when the vibration generator 101 is dropped from a certain height is applied to the vibration generator 101 and vibrating elements VB move significantly in the direction indicated by the arrow labeled “AR4” in the lower figure in FIG. 15, the movement of the vibrating element VB including the lower yoke 10D in the X-axis direction can be blocked reliably. Furthermore, each protruding part 31 in the base member 2 is formed by shaping a part of the bottom plate part 2B into a mountain-like protrusion pointing in the Z1 direction. By this means, the furthermost positions in the X-axis direction that the vibrating elements VB cannot cross can be set more accurately than when blocking the movement of the vibrating elements VB in the X-axis direction by bending the outermost sides of the bottom plate part 2B in the X-axis direction in the Z1 direction, so that the strength of the protruding parts 31 can be improved in a simple manner. Furthermore, by bringing the inner edge surface 22b that each aperture 22 formed in the lower yoke 10D has on the opposite side relative to a corresponding protruding part 21 and the end surface 31a that each protruding part 31 formed in the base member 2 has nearest to a corresponding aperture 32, that is, the end surface 31a facing a corresponding aperture 32, into contact with each other, the movement of the vibrating elements VB including the lower yoke 10D in the X-axis direction is blocked. This allows the size of the vibrating elements VB in the X-axis direction to be smaller than when a stopper mechanism for blocking the movement of vibrating elements VB in the X-axis direction is provided outward to both end sides of the lower yoke 10D in the X-axis direction. Also, the movement of vibrating elements VB including the lower yoke 10D in the X-axis direction is blocked by bringing an inner edge surface 22b of each aperture 22 and an end surface 31a that each protruding part 31 has nearest to a corresponding aperture 32 into contact with each other, and the movement of the vibrating elements VB including the lower yoke 10D in the X-axis direction is blocked by bringing end surfaces formed in sheet materials into contact with each other. Therefore, the strength of the stopper mechanism for blocking the movement of vibrating elements VB in the X-axis direction can be improved.

Thus, according to the present embodiment, in order to block the movement of vibrating elements VB in the X-axis direction, a protruding part 31 is formed in a part of the base member 2 positioned along both end sides of the base member in the X-axis direction. The protruding parts 31, formed along both end sides of the base member 2 in the X-axis direction, partially overlap the protruding parts 21 formed in the lower yoke 10D, in the Z-axis direction, and can be inserted under the protruding parts 21. This allows effective use of the space created underneath the protruding parts 21, thus achieving improved space efficiency. Also, since the protruding parts 31 are formed in a mountain-like shape in which each protruding part 31 is highest in its center in the Y-axis direction and gradually becomes lower toward its ends in the Y-axis direction, and the parts of each protruding part 31 that meet both ends of a corresponding aperture 32 in the Y-axis direction are the edging parts of the protruding part 31, the strength of the protruding parts 31 can be improved compared to when both ends of the protruding parts 21 in the Y-axis direction are connected vertically with the bottom plate part 2B.

Also, similar to the apertures 22 of the lower yoke 10D, the apertures 32 in the base member 2 are formed next to respective protruding parts 31, so that the apertures 22 formed in the lower yoke 10D and the apertures 32 formed in the base member 2 make it easier to align the positions of the lower yoke 10D and the base member 2, as will be described later.

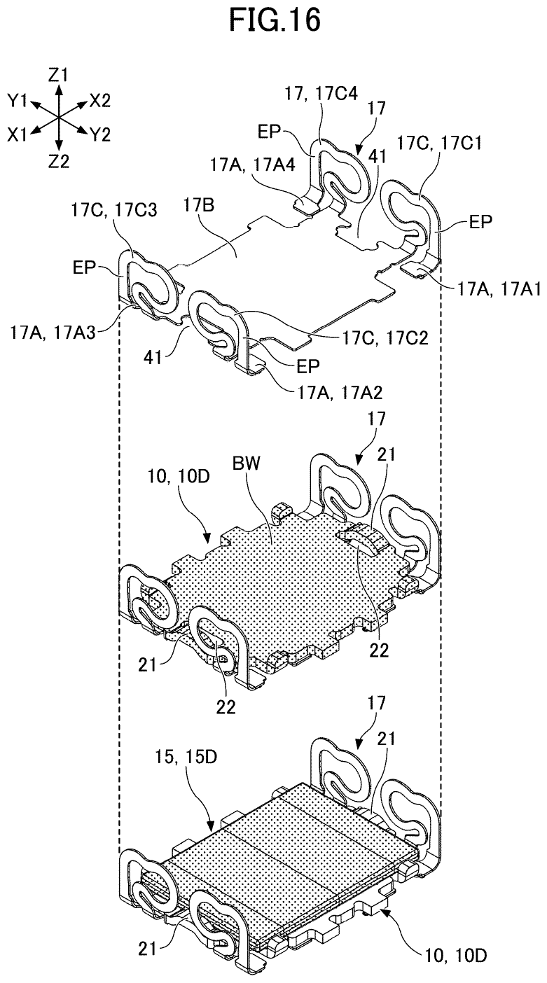

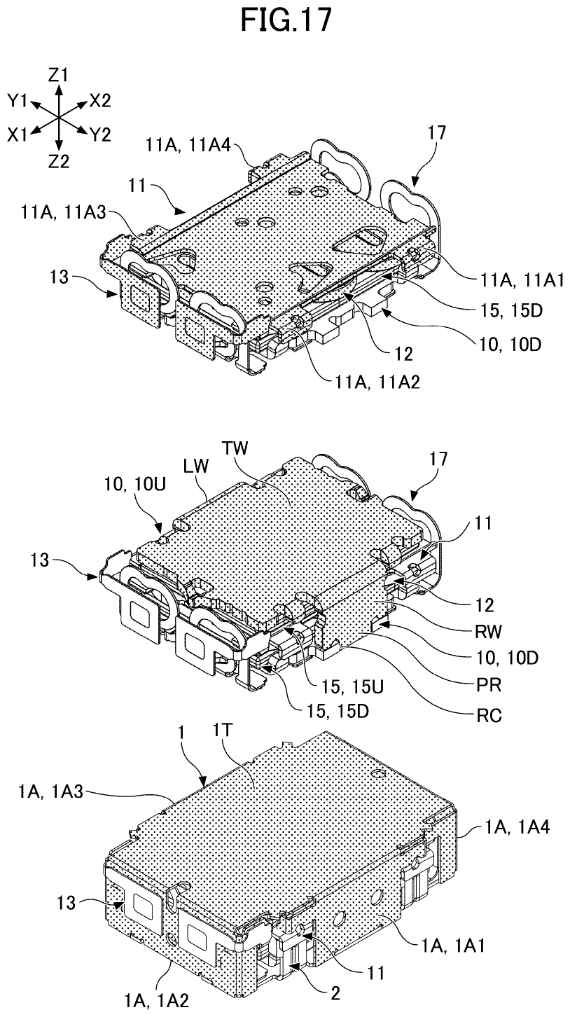

Next, how to assemble the vibration generator 101 will be described below with reference to FIG. 16 and FIG. 17. FIG. 16 and FIG. 17 are perspective views of individual components that constitute the vibration generator 101. Note that, in FIG. 16 and FIG. 17, components that are newly attached and assembled together are shown with a dot pattern for ease of understanding.

To be more specific, the uppermost figure in FIG. 16 is a perspective view of the flat spring 17, the middle figure in FIG. 16 is a perspective view of the flat spring 17 to which the lower yoke 10D is attached, and the lowermost figure in FIG. 16 is a perspective view of the flat spring 17 to which the lower magnet 15D is additionally attached.

The uppermost figure in FIG. 17 is a perspective view of the flat spring 17 to which the bracket 11 and the coils 12 are additionally attached, the middle figure in FIG.

17 is a perspective view of the flat spring 17 to which the upper magnet 15U, the upper yoke 10U, and the wire boards 13 are additionally attached, and the lowermost figure in FIG. 17 is a perspective view of the flat spring 17 to which the cover member 1 and the base member 2 are additionally attached, that is, a perspective view of the vibration generator 101.

First, referring to the middle figure in FIG. 16, the lower yoke 10D is laid over the upper surface of the vibrating element support part 17B of the flat spring 17. In the example illustrated, the bottom plate part BW of the lower yoke 10D is laid over the upper surface of the vibrating element support part 17B without using an adhesive. Then, from the flat spring 17 side, the vibrating element support part 17B and the lower yoke 10D are welded together. When doing so, the flat spring 17 and the lower yoke 10D may be joined together such that part of the outer shape of the notches 41 formed in the vibrating element support part 17B of the flat spring 17 overlaps the apertures 22 formed in the bottom plate part BW of the lower yoke 10D, so that the positions of the flat spring 17 and the lower yoke 10D can be aligned easily. Note that a vibration-damping steel sheet (not shown), which is a reinforcing material for preventing or substantially preventing the erect part EP of each elastic arm part 17C of the flat spring 17 from bending, may be applied to the outer surface of each erect part EP.

Next, as shown in the lowermost figure in FIG. 16, the lower magnet 15D is laid over the upper surface of the bottom plate part BW of the lower yoke 10D. In the example illustrated, the lower yoke 10D and the lower magnet 15D stick together by magnetic force, which holds the lower magnet 15D onto the lower yoke 10D. The lower magnet 15D is not joined by laser welding or by an adhesive. However, the lower yoke 10D and the lower magnet 15D may be joined and held together by laser welding or by an adhesive. In that case, the lower magnet 15D may be laid over the upper surface of the bottom plate part BW so as to fit in between the two protruding parts 21 formed in the bottom plate part BW of the lower yoke 10D. This allows the position of the lower magnet 15D to be adjusted relative to the lower yoke 10D. Therefore, it is preferable if the spacing between the opposing end surfaces of the two protruding parts 21 in the bottom plate part BW of the lower yoke 10D is substantially equal to the length of the lower magnet 15D in the X-axis direction. Considering tolerances, the spacing between the opposing end surfaces of the two protruding parts 21 in the bottom plate part BW of the lower yoke 10D may be made slightly wider than the length of the lower magnet 15D in the X-axis direction.

Next, as shown in the uppermost figure in FIG. 17, the non-vibrating part NV is attached onto the lower magnet 15D. In the example illustrated, the bracket 11, the coils 12, and the wire boards 13 constitute the non-vibrating part NV together. Note that, before the non-vibrating part NV is attached onto the lower magnet 15D, the coils 12 and the bracket 11 are joined together using an adhesive, and the wire boards 13 and the bracket 11 are joined together using a double-sided tape.

Next, as shown in the middle figure in FIG. 17, the upper yoke 10U, to which the upper magnet 15U is attached, is laid over the bracket 11. Then, the recessed parts RC formed in the lower yoke 10D and the projecting parts PR formed in the upper yoke 10U engage with each other. Note that, before the upper yoke 10U and the lower yoke 10D are joined together, the upper magnet 15U is placed below the top plate part TW of the upper yoke 10U, in the same way that the lower magnet 15D is laid over the upper surface of the bottom plate part BW of the lower yoke 10D. The upper yoke 10U and the upper magnet 15U stick together by magnetic force, so that the upper magnet 15U is attached to the upper yoke 10U. The upper magnet 15U is not joined by laser welding or by an adhesive. However, the upper yoke 10U and the upper magnet 15U may be joined and held together by laser welding or by an adhesive. In that case, too, the upper yoke 10U is placed below the top plate part TW such that the upper magnet 15U fits in between the two protruding parts 23 formed in the top plate part TW of the upper yoke 10U. This allows the position of the upper magnet 15U to be adjusted relative to the upper yoke 10U. Therefore, it is preferable if the spacing between the opposing end surfaces of the two protruding parts 23 formed in the top plate part TW of the upper yoke 10U is substantially equal to the length of the upper magnet 15U in the X-axis direction. Considering tolerances, the spacing between the opposing end surfaces of the two protruding parts 23 in the top plate part TW of the upper yoke 10U may be made slightly wider than the length of the upper magnet 15U in the X-axis direction.

Then, as shown in the lowermost figure in FIG. 17, the members stacked together as described above are housed in the cover member 1, which is then covered with the base member 2. Although the support parts 2P of the base member 2 and the anchoring parts 11A of the bracket 11 engage with each other, before the members are housed in the cover member 1 as described above, the support parts 2P of the base member 2 and the anchoring parts 11A of the bracket 11 may be joined together by fastening members, by crimping, by laser welding, by an adhesive, etc.

Then, the upper yoke 10U and the lower yoke 10D are joined together at a position where they do not come into contact with the non-vibrating part NV. To be more specific, the upper yoke 10U and the lower yoke 10D are joined together by welding or the like, through the yoke joint holes 33 formed in the base member 2, in parts where the recessed parts RC formed in the lower yoke 10D and the projecting parts PR formed in the upper yoke 10U engage with each other.

Also, at joining positions provided in the base member 2, the connecting parts 17A of the flat spring 17 are joined to the upper surface of the bottom plate part 2B of the base member 2 by laser welding. When this is done, the flat spring 17 and the base member 2 may be joined together such that part of the outer shape of the notches 41 formed in the vibrating element support part 17B of the flat spring 17 and part of the outer shape of the apertures 32 formed in the bottom plate part 2B of the base member 2 overlap each other, so that the positions of the flat spring 17 and the base member 2 on the XY plane can be aligned easily, and, furthermore, the position of the base member 2 can be easily aligned relative to the lower yoke 10D joined together with the flat spring 17.

Also, the lower ends of the outer wall parts 1A of the cover member 1 and the edge parts of the bottom plate part 2B of the base member 2 are joined together by laser welding. Note that the cover member 1 and the base member 2 may be joined together by fastening members, by an adhesive, by crimping, etc.

The vibration generator 101 is assembled thus. Note that the adhesive to be used in the above-described assembling process may be a thermosetting adhesive, a light-curing adhesive, a moisture-curing adhesive, a hybrid adhesive, which is a combination of these, etc. In the example illustrated, a thermosetting adhesive is used.

Also, the placement of the base member 2 and the laser welding of the flat spring 17 to the connecting parts 17A may be carried out between the process shown by the middle figure in FIG. 16 and the process shown by the lowermost figure in FIG. 16.

Note that the protruding parts 21 of the lower yoke 10D and the protruding parts 23 of the upper yoke 10U may be formed such that multiple mountain-like shapes are aligned in the Y-axis direction; in this case, the mountain-like shapes may have varying heights.

Also, despite the description given hereinabove, the first movable-body apertures of the present disclosure are by no means limited to the apertures 22, which are rectangles with rounded corners, formed such that the edge part that each aperture 22 has nearest to a protruding part 21 extends in the Y-axis direction, and the first movable-body apertures may be provided in the form of slits that extend in the Y-axis direction. Similarly, the second movable-body apertures are not limited to the apertures 24, which are rectangles with rounded corners, formed such that the edge part that each aperture 24 has nearest to a protruding part 23 extends in the Y-axis direction, and the second movable-body apertures may be provided in the form of slits that extend in the Y-axis direction.

Furthermore, elements that are the same or substantially the same as the protruding parts 31 formed in the base member 2 may be provided in the cover member 1 to block the movement of vibrating elements VB in the X-axis direction. In this case, the protruding parts in the cover member 1 may protrude in the 22 direction and have a height that enables each protruding part to be positioned above a protruding part 23 formed in the upper yoke 10U. In this case, the movement of vibrating elements VB in the X-axis direction can be blocked at two points, up and below, thereby improving the strength of the vibration generator 101.

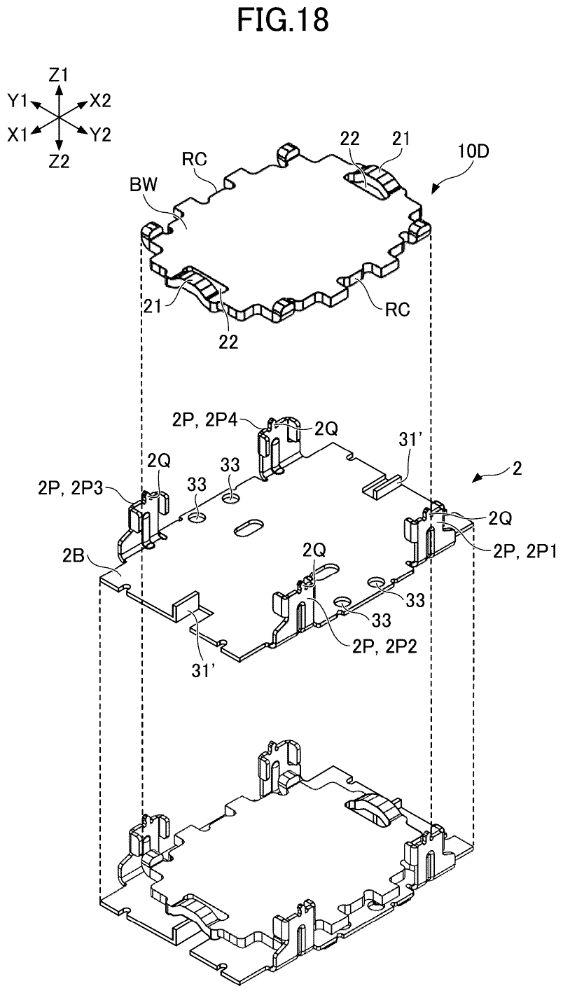

FIG. 18 shows an alternative vibration generator, showing example structures of its lower yoke 10D and base member 2, and corresponds to FIG. 10. In the vibrating device shown in FIG. 10, each of the protruding parts 31 in the base member 2 is shaped like a mountain such that its center part is a protrusion in the Y-axis direction. The alternative example of FIG. 18 is different from that of FIG. 10 in that the protruding parts 31′ of FIG. 18 are vertical sheet surfaces formed by cutting and erecting parts of the base member 2. In this alternative example, again, the end surface that each protruding part 31′ has nearest to the center of the base member 2 in the X-axis direction comes into contact with an inner edge surface 22b of an aperture 22, thus blocking the movement of vibrating elements VB in the X-axis direction.

A preferred embodiment and an alternative example of the present disclosure have been described above in detail. However, the present disclosure is by no means limited to the herein-contained description, and, for example, the above embodiment and alternative example may be modified, substituted, etc., in a variety of ways, without departing from the scope of the present disclosure. In addition, the technical features described herein may be combined as appropriate insofar as technical inconsistencies do not arise.

What is claimed is:

1. A vibration generator comprising:
a first fixed body having a bottom plate part that extends in a first direction and a second direction that is perpendicular to the first direction;
a first movable body having a first permanent magnet and a first yoke, the first movable body being positioned above the bottom plate part, at a distance from the bottom plate part in a third direction that is perpendicular to the first and second directions;
a support member configured to support the first movable body such that the first movable body is allowed to vibrate in the first direction, relative to the first fixed body; and
main wire bundles and sub wire bundles of coils, positioned above the first movable body, at a distance from the first movable body in the third direction, and directly or indirectly attached to the first fixed body, each main wire bundle of coils being composed of a plurality of conductive wires that extend in the second direction, and each sub wire bundle of coils bridging two neighboring main wire bundles of coils,
wherein the first permanent magnet is attached to the first yoke and positioned below the coils,
wherein the first permanent magnet produces a first magnetic flux that travels from the first permanent magnet to the main wire bundles of coils and a second magnetic flux that travels from the main wire bundles of coils to the first permanent magnet,
wherein the first yoke is positioned below the first permanent magnet in the third direction,
wherein the first yoke includes:
a first planar part on which the first permanent magnet is placed; and
first movable-body apertures formed in respective positions in the first planar part along a first end side and a second end side of the first planar part, the first end side and the second end side being opposite end sides of the first planar part in the first direction,
wherein, where each first movable-body aperture has a plurality of edges in the first direction, an edge that is positioned nearest to the first or second end side of the first planar part, along which said each first movable-body aperture is formed, extends in the second direction,
wherein first movable-body protruding parts are formed in respective positions in the first planar part along the first end side and the second end side of the first planar part, each first movable-body protruding part being formed by shaping a part of the first planar part into a protrusion that points upward in the third direction, and being positioned between: the first or second end side of the first planar part along which said each first movable-body protruding part is formed; and a first movable-body aperture formed along a same end side of the first planar part as where said each first movable-body protruding part is formed, and
wherein, where each first movable-body protruding part has a plurality of lateral surfaces that are positioned further from and nearer to the first movable-body aperture formed along the same end side of the first planar part as where said each first movable-body protruding part is formed, the first permanent magnet is held between respective lateral surfaces of the first movable-body protruding parts that are positioned nearest to the first movable-body apertures.

2. The vibration generator according to claim 1,
wherein fixed-body protruding parts are formed in respective positions in the first fixed body where the fixed-body protruding parts and the first movable-body protruding parts at least partially overlap each other in the third direction, each fixed-body protruding part being formed by shaping a part of the bottom plate part into a protrusion that points upward in the third direction, and
wherein, where each first movable-body aperture has a plurality of inner edge surfaces in the first direction and each fixed-body protruding part has a plurality of lateral surfaces in the first direction, an inner edge surface of said each first movable-body aperture that is positioned furthest from the first or second end side of the first planar part along which said each first movable-body aperture is formed, and a lateral surface of said each fixed-body protruding part that is positioned nearest to a center of the first fixed body in the first direction, are brought into contact with each other, so that movement of the first movable body in the first direction is blocked.

3. The vibration generator according to claim 2,
wherein fixed-body apertures are formed in respective positions in the first fixed body along the first and second end sides of the first fixed body in the first direction,
wherein, where each fixed-body aperture has a plurality of edges, an edge that is positioned nearest to the first or second end side of the first fixed body along which said each fixed-body aperture is formed extends in the second direction, and
wherein the fixed-body protruding parts are formed between each fixed-body aperture and the first or second end side of the first fixed body along which said each fixed-body aperture is formed.

4. The vibration generator according to claim 2, wherein the fixed-body protruding parts are wider in the first direction than the first movable-body protruding parts.

5. The vibration generator according to claim 3, further comprising:
a second fixed body having a top plate part that extends in the first and second directions, and fixed to the first fixed body; and
a second movable body having a second permanent magnet and a second yoke, and positioned below the top plate part in the third direction,
wherein the support member supports the first movable body and the second movable body such that the first movable body and the second movable body are allowed to vibrate in the first direction, relative to the first fixed body and the second fixed body,
wherein the coils are positioned below the second movable body in the third direction,
wherein the second permanent magnet is attached to the second yoke and positioned above the coils,
wherein the second permanent magnet produces a third magnetic flux that travels from the second permanent magnet to the main wire bundles of coils and a fourth magnetic flux that travels from the main wire bundles of coils to the second permanent magnet,
wherein the second yoke and the main wire bundles of coils are positioned opposite each other across the second permanent magnet in the third direction,
wherein the second yoke includes:
a second planar part on which the second permanent magnet is placed; and
second movable-body apertures formed in respective positions in the second planar part along a first end side and a second end side of the second planar part, the first end side and the second end side being opposite end sides of the second planar part in the first direction,
wherein, where each second movable-body aperture has a plurality of edges in the first direction, an edge that is positioned nearest to the first or second end side of the second planar part, along which said each second movable-body aperture is formed, extends in the second direction,
wherein second movable-body protruding parts are formed in respective positions in the second planar part along the first end side and the second end side of the second planar part, each second movable-body protruding part being formed by shaping a part of the second planar part into a protrusion that points downward in the third direction, and being positioned between: the first or second end side of the second planar part along which said each second movable-body protruding part is formed; and a second movable-body aperture formed along a same end side of the second planar part as where said each second movable-body protruding part is formed, and
wherein, where each second movable-body protruding part has a plurality of lateral surfaces that are positioned further from and nearer to the second movable-body aperture formed along the same end side of the second planar part as where said each second movable-body protruding part is formed, the second permanent magnet is held between respective lateral surfaces of the second movable-body protruding parts that are positioned nearest to the second movable-body apertures.

6. The vibration generator according to claim 3,
wherein the support member is fixed to the first fixed body such that part of the support member is positioned between the first fixed body and the first yoke in the third direction,
wherein notches are formed in parts of the support member positioned between the first fixed body and the first yoke, and
wherein respective outer shapes of the first movable-body apertures, the fixed-body apertures, and the notches at least partially have a same shape and overlap each other when viewed from the third direction.

7. The vibration generator according to claim 1, wherein the first movable-body apertures are slits.
